(19) United States
(12) Patent Application Publication
(10) Pub. No.: US 2007/0258487 A1
(43) Pub. Date: Nov. 8, 2007

(54) Signalling Service Information Data and Service Information Fec Data in a Communication Network

(76) Inventor: Matti Puputti, Turku (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 10/574,244

(22) PCT Filed: Sep. 28, 2004
(86) PCT No.: PCT/IB04/51897

§ 371 Date: Mar. 2, 2007

(30) Foreign Application Priority Data
Sep. 29, 2003 (GB) 0322775.8

(51) Int. Cl. H04N 7/26

(52) U.S. Cl. 370/474

(57) ABSTRACT

A multiprotocol encapsulation (MPE) encapsulator (6) receives or generates a copy or partial copy (10′) of service information data (10) and generates associated forward error correction (FEC) data. In addition to transmitting service information data in a conventional way via a first set of channels, the MPE encapsulator transmits the copy 10′ and the associated FEC data via a second set of channels.

### FIELD OF THE INVENTION

The present invention relates to a method and system of signalling in a communications network, particularly, although not exclusively, to a method and system of signalling service information in a digital broadband broadcasting network.

### BACKGROUND ART

Mobile communications systems are known which can provide enough bandwidth to allow streaming of video using advanced compression techniques, such as MPEG-4.

Together with International Organisation for Standards/International Electrotechnical Commission (ISO/IEC) Standard 13818-1 “Information Technology-Generic coding of moving pictures and associated audio information: Systems”, European Telecommunications Standards Institute (ETSI) EN 300 468 “Digital Video Broadcasting (DVB); Specification for Service Information (SI) in DVB systems” V1.5.1 (2003-01) specifies Service Information (SI) data to help a user select services and to allow a DVB receiver to configure itself for the selected service.

ISO/IEC 13818-1 specifies Service Information (SI) data referred to as Program Specific Information (PSI) data. PSI/SI data is arranged in four types of table, namely a Program Association Table (PAT), a Conditional Access Table (CAT), a Program Map Table (PMT) and a Network Information Table (NIT). A PAT is provided for each service in a transport stream and indicates the location of a corresponding PMT which in turn identifies and indicates the location of the elementary stream making up that service. The PAT also gives the location of the NIT.

EN 300 468 specifies mandatory and optional SI data to help the user identify and select services. SI data is arranged in nine tables, namely a Bouquet Association Table (BAT), a Service Description Table (SDT), an Event Information Table (EIT), a Running Status Table (RST), a Time and Date Table (TDT), a Time Offset Table (TOT), a Stuffing Table (ST), a Selection Information Table (SIT) and a Discontinuity Information Table (DIT). EN 300 468 also specifies the NIT in compliance with ISO/IEC 13818-1.

The PSI/SI and SI data tables are segmented into sections, placed in transport stream (TS) packets and transmitted together with transport stream packets carrying one or more services in a stream via a physical channel to the DVB receiver.

Errors can be introduced during transmission, particularly in a terrestrial DVB (DVB-T) system, which can affect the PSI/SI and SI data. Loss or corruption of PSI/SI and SI data tables can limit the ability of a user to identify and select services. A possible solution to this problem is to request and receive recovery data to correcting for errors via the mobile communications system. However, it is desirable to avoid using the mobile communications system for this purpose.

The present invention seeks to provide a method and system of signalling.

### BRIEF SUMMARY OF THE INVENTION

According to a first aspect of the present invention there is provided a method of signalling in a communications network in which service information data is transmitted via a first set of channels, the method comprising providing a copy of at least some of said service information data providing forward error correction (FEC) data for said copy and transmitting said copy and said FEC data via a second, different set of channels.

The copy of said at least some of said service information data may comprise a first plurality of data packets and said FEC data may comprise a second plurality of data packets and the method may further comprise placing said first plurality of data packets in a first plurality of sections and placing said second plurality of data packets in a second plurality of sections.

The method may further comprise arranging said first plurality of sections into a first set of bursts and arranging said second plurality of sections into a second set of bursts.

The method may further comprise placing said first plurality of sections in a first plurality of packets and placing said first plurality of sections in a second plurality of packets. The method may further comprise labelling said first plurality of packets with a first packet identifier and labelling said second plurality of packets with a second packet identifier.

The method may comprise providing a first parameter for indicating a timing offset between a first, earlier burst comprising at least some of said copy of said at least some of said service information data and a second, later burst comprising further of said copy of said at least some of said service information data and providing a second parameter for indicating a timing offset between a third, earlier burst comprising at least some of said FEC data and a fourth, later burst comprising further FEC data.

The method may further comprise placing said first parameter in a section included in said first burst and placing said second parameter in a section included in said second burst.

The method may further comprise including in said service information a parameter for indicating that said copy is being transmitted via said second channel. The method may further comprise including in said service information a parameter for indicating that said FEC data is being transmitted via said third channel. The method may further comprise including in said service information a parameter for indicating that said copy is being transmitted in a set of time-sliced bursts. The method may further comprise including in said service information a parameter for indicating that said FEC data is being transmitted in a set of time-sliced bursts. The method may comprise providing a copy of at least some other part of said service information data and transmitting said copy of said at least some other part of said service information data via said second, different set of channels.

The method may comprise transmitting part of said service information data as part of forward error correction data.

The at least part of said service information may comprise at least part of least some PSI/SI data table sections and/or at least part of at least some one or more SI data table sections.

According to a second aspect of the present invention there is provided a method of signalling in a communications network in which service information data is transmitted via a first set of channels, the method comprising providing a first copy of a first part of said service information data providing forward error correction (FEC) data for said copy, providing a second copy of a second part of said service information data and transmitting said first copy and said FEC data and said second copy via a second, different set of channels.

According to a third aspect of the present invention there is provided a method of signalling in a communications network in which service information data is transmitted, the method comprising providing forward error correction (FEC) data for at least some of said service information data; and transmitting said at least some of said service information data and said FEC data.

The method may comprise transmitting said service information data via a first set of channels and transmitting said at least some of said service information data and said FEC data via a second, different set of channels.

According to a fourth aspect of the present invention there is provided a method of transmitting service information, the method comprising transmitting at least part of service information data as part of forward error correction data.

The service information data may include service information parameters.

According to a fifth aspect of the present invention there is provided a computer program comprising computer program instructions for causing data processing apparatus to perform the method.

According to a sixth aspect of the present invention there is provided a method of operating a terminal configured to receive service information transmitted via a first set of channels, the method comprising receiving a copy of at least some of said service information data and FEC data for said copy via a second, different set of channels.

The method may comprise decoding said copy of at least some of said service information data and said FEC data for said copy so as to so produce a corrected version of said copy of said at least some of said service information data.

The method may comprise receiving a copy of at least some other part of said service information and which does not have FEC data via said second, different set of channels.

According to a seventh aspect of the present invention there is provided a method of operating a terminal configured to receive service information, the method comprising receiving at least some service information data and FEC data for said at least some service information data.

The method may comprise receiving service information data via a first set of channels and receiving said at least some service information data and FEC data for said at least some service information data via a second, different set of channels.

According to an eighth aspect of the present invention there is provided a method of receiving service information, the method comprising receiving at least part of service information data as part of forward error correction data.

According to a ninth aspect of the present invention there is provided a computer program comprising computer program instructions for causing a terminal to perform the method.

According to a tenth aspect of the present invention there is provided a system of signalling in a communications network in which service information is transmitted via a first set of channels, the system comprising providing a copy of at least some of said service information data, providing forward error correction (FEC) data for said copy and transmitting said copy and said FEC data via a second, different set of channels.

According to an eleventh aspect of the present invention there is provided a system of signalling in a communications network in which service information data is transmitted, the system comprising providing forward error correction (FEC) data for at least some of said service information data and transmitting said at least some of said service information data and said FEC data.

The system may comprise transmitting said service information data via a first set of channels and transmitting said at least some of said service information data and said FEC data via a second, different set of channels.

According to a twelfth aspect of the present invention there is provided a system of transmitting service information, the system comprising transmitting at least part of service information data as part of forward error correction data.

According to a thirteenth aspect of the present invention there is provided a network element configured to signal service information via a first set of channels, the network element comprising means for providing a copy of at least some of said service information data, means for providing forward error correction (FEC) data for said copy and means for transmitting said copy and said FEC data via a second, different set of channels.

According to a fourteenth aspect of the present invention there is provided a network element for signalling service information, the network element comprising means for providing forward error correction (FEC) data for at least some of said service information data and means for transmitting said at least some of said service information data and said FEC data.

The network element may be configured to transmit service information data via a first set of channels and to transmit said at least some of said service information data and said FEC data via a second, different set of channels.

The network element may be an encapsulator.

According to a fifteenth aspect of the present invention there is provided a transmitter for signalling service information in a communications network, the transmitter comprising means for providing forward error correction (FEC) data for at least some service information data and means for transmitting said at least some of said service information data and said FEC data.

The transmitter may be configured to transmit service information data via a first set of channels and to transmit said at least some of said service information data and said FEC data via a second, different set of channels.

According to a sixteenth aspect of the present invention there is provided a transmitter for signalling service information in a communications network, the transmitter comprising means for transmitting at least some of said service information data and said FEC data.

According to a seventeenth aspect of the present invention there is provided terminal configured to receive service information transmitted via a first channel, comprising means for receiving a copy of at least some of said service information data and FEC data for said copy via a second, different set of channels.

According to an eighteenth aspect of the present invention, there is provided a terminal configured to receive service information, comprising means for receiving at least some of service information data and forward error correction (FEC) data for said at least some of said service information.

The terminal may be configured to receive service information data via a first set of channels and to receive said at least some of said service information data and said FEC data via a second, different set of channels.

According to nineteenth aspect of the present invention, there is provided a receiver for receiving service information, the receiver comprising means for receiving forward error correction (FEC) data for at least part of transmitting part of service information data as part of forward error correction data.

According to a twentieth aspect of the present invention there is provided a receiver for receiving service information from a communications network, the receiver comprising means for receiving at least some of said service information as at least part of FEC data.

### BRIEF DESCRIPTION OF THE DRAWINGS

Embodiments of the present invention will now be described by way of example with reference to the accompanying drawings in which:

FIG. 1 shows an embodiment of a communication system according to an embodiment of the present invention;

FIG. 2 shows an embodiment of a multiprotocol encapsulation (MPE) encapsulator which outputs transport stream packets carrying time-sliced bursts in accordance with one embodiment of the present invention;

FIG. 3 illustrates the schematical structure of an exemplary transport stream packet according to an embodiment of the present invention;

FIG. 4 is a schematic diagram of an embodiment of an MPE encapsulator according to an embodiment of the present invention;

FIG. 5 is a process flow diagram of a first process performed by the MPE encapsulator shown in FIG. 4 according to an embodiment of the present invention;

FIGS. 6a, 6b and 6c show a process by which forward error correction (FEC) data is calculated in one embodiment of the present invention;

FIG. 7 shows Service Information (SI) data packets being placed in SI sections in one embodiment of the present invention;

FIG. 8 shows SI-FEC data packets being placed in SI-FEC sections in one embodiment of the present invention;

FIG. 9 illustrates an example of a section according to an embodiment of the present invention;

FIG. 10 illustrates an exemplary SI data burst;

FIG. 11 illustrates exemplary SI-FEC data bursts;

FIG. 12 illustrates an exemplary application data burst;

FIG. 13 illustrates exemplary MPE-FEC data bursts;

FIG. 14 shows transmission of SI data bursts, SI-FEC data bursts, MPE data bursts, MPE-FEC data bursts in one embodiment of the present invention;

FIG. 15 illustrates exemplary encapsulation of SI sections in transport stream packets;

FIG. 16 illustrates exemplary encapsulation of SI-FEC sections in transport stream packets;

FIG. 17 illustrates exemplary encapsulation of MPE sections in transport stream packets;

FIG. 18 illustrates exemplary encapsulation of MPE-FEC sections in transport stream packets;

FIG. 19 shows exemplary multiplexing of transport stream packets;

FIG. 20 shows specification of a PID in a time slice and FEC descriptor in accordance with one embodiment of the present invention;

FIG. 21 illustrates inclusion of the time slice and FEC descriptor of FIG. 20 into a Network Interface Table (NIT);

FIG. 22 is a process flow diagram of a second process performed by the MPE encapsulator shown in FIG. 4;

FIG. 23 illustrates segmentation of the NIT shown in FIG. 21 and mapping into transport stream packets;

FIG. 24 illustrates a process of copying PSI/SI and SI data and generating SI data packets and associated FEC data packets in accordance with an embodiment of the present invention;

FIG. 25 is a schematic diagram of a mobile telephone handset to an embodiment of the present invention;

FIG. 26 shows functional elements of the mobile telephone handset of FIG. 25 for receiving and processing time-sliced bursts according to an embodiment of the present invention; and

FIG. 27 is process flow diagram of a process of preparing for, receiving and processing time-sliced bursts performed by the mobile telephone handset shown in FIG. 25.

### DETAILED DESCRIPTION OF THE INVENTION

Communication Network 1

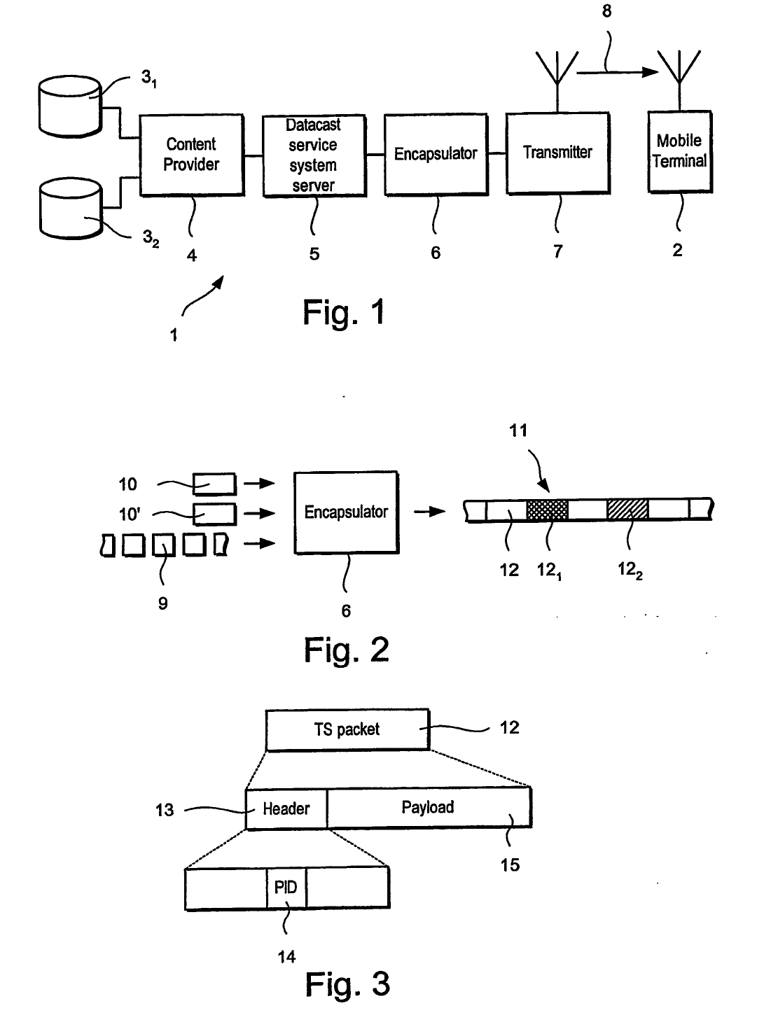

Referring to FIG. 1, a communications network 1 for delivering content to a mobile terminal 2 is shown. The communications network 1 includes a terrestrial digital video broadcasting (DVB-T) network which is used as a broadcast access network to deliver content as an Internet Protocol Data Casting (IPDC) service. However, other digital broadcast networks may be used including other types of DVB networks; such as a cable DVB (DVB-C) network or satellite DVB (DVB-S) network, a Digital Audio Broadcasting (DAB) network, an Advanced Television System Committee (ATSC) network or an Integrated Services Digital Broadcasting (ISDB) network.

The communications network 1 includes sources 3₁, 3₂ of content, for example in the form of video, audio and data files, a content provider 4 for retrieving, re-formatting and storing content, a datacast service system server 5 for determining service composition, a multi-protocol encapsulation (MPE) encapsulator 6 in accordance with the present invention and a transmitter 7 for modulating and broadcasting a signal 8 to receivers (not shown) including mobile terminal 2.

Referring to FIG. 2, the MPE encapsulator 6 receives a stream of data 9 and service information data 10 and, optionally, a copy or partial copy 10′ of service information data 10, and generates a transport stream 11 comprising MPEG-2 transport stream (TS) packets 12, 12₁, 12₂, typically 188 bytes long, according to International Organisation for Standards/International Electrotechnical Commission (ISO/IEC) Standard 13818-1 “Information technology—Generic coding of moving pictures and associated audio information: Systems”.

The service information data 10 comprises MPEG program specific information (PSI) data and DVB Service Information (SI) data.

Together with ISO/IEC 13818-1, European Telecommunications Standards Institute (ETSI) EN 300 468 “Digital Video Broadcasting (DVB); Specification for Service Information (SI) in DVB systems” V1.5.1 (2003-01) specifies SI data to help a user select services and to allow a DVB receiver to configure itself for the selected service.

ISO/IEC 13818-1 specifies SI data referred to as PSI data. PSI data is arranged as four types of table, namely a Program Association Table (PAT), a Conditional Access Table (CAT), a Program Map Table (PMT) and a Network Information Table (NIT). A PAT is provided for each service in a multiplex and indicates the location of a corresponding PMT which identifies and indicates the location of a stream making up that service. The PAT also gives the location of the NIT.

EN 300 468 specifies SI data to help the user identify and select services. The SI data is arranged in nine tables, namely a Bouquet Association Table (BAT), a Service Description Table (SDT), an Event Information Table (EIT), a Running Status Table (RST), a Time and Date Table (TDT), a Time Offset Table (TOT), a Stuffing Table (ST), a Selection Information Table (SIT) and a Discontinuity Information Table (DIT). EN 300 468 also specifies the NIT in compliance with ISO/IEC 13818-1. Some SI data tables are mandatory, such as the NIT and SDT for a transport stream, and some are optional, such as an NIT for another network or an SDT for different transport stream.

Referring also to FIG. 3, the transport stream 11 (FIG. 2) is divided into a number of logical channels, referred to as “elementary streams”. The elementary stream to which a TS packet 12 belongs is defined in a packet header 13 using a packet identifier (PID) 14. The packet identifier 14 can be used to identify contents of a TS packet payload 15.

For example, the contents of a first TS packet 12₁ may be identified as containing all or part of a network information table (NIT) by specifying PID=0x0010 (as a hexadecimal number). The contents of a second TS packet 12₂ may be identified as being video, audio or another type of data by specifying a PID value between 0x0030 to 0x1FFE (as hexadecimal number).

Thus, a set of channels, i.e. a set of elementary streams, is used to transmit PSI/SI data.

Referring again to FIG. 1, the DVB transmitter 7 receives a signal from the encapsulator 6 which it modulates, amplifies and broadcasts as signal 8.

Other network elements may be provided, such as a multiplexer (not shown) for combining a plurality of services and a gap-filler transmitter for receiving and re-transmitting the signal 8. Furthermore, another communications network (not shown), such as a public land mobile network preferably in the form a 2^{nd} or 3^{rd} generation mobile network such as GSM or UMTS respectively, may be provided for providing a return channel from the mobile terminal 2 to the communications network 1. A further communications network (not shown), such as the Internet, may be provided to connect distributed elements of the communications network 1, such as content provider 4 and service system server 5.

As will be explained in more detail later, the MPE encapsulator 6 receives or generates a copy or partial copy 10′ of the service information data 10 or a part of the service information data 10 and generates forward error correction (FEC) data. The copied data 10′ and associated FEC data are encapsulated to generate so-called “SI sections” and “SI-FEC sections” respectively. The SI and SI-FEC sections may be assembled into respective sets of time-sliced bursts and transmitted in TS packets 12 having the same PID or different PIDs. In other words, another set of channels, i.e. another set of elementary streams, is used transmit the copy 10′ of the service information and associated FEC data.

A channel for time-sliced burst transmission, time slicing channel, comprises transmission time periods. During these transmission time periods, time slicing bursts are transmitted and the time for the next burst, referred to as “delta-t”, is signalled. Delta-t is not necessarily fixed. Between transmission periods, other time slicing channels can be transmitted. Each time slicing channel has their own PID value. It is also possible to multiplex two or more time slicing channels into one time period, because they can be separated (demultiplexed) according to the PID value.

Thus, the mobile terminal 2 can receive not only service information data 10 in the usual way, but also a copy or partial copy 10′ of the service information data 10, together with FEC data for enabling correction of the copied data 10′. If the service information data 10 received in the usual way is corrupted due to poor transmission conditions, service information data may still be acquired because errors in the copied data 10′ can be corrected. In one embodiment of the invention the availability of a copy or partial copy 10′ of the service information may be signalled for example in the Transmission Parameter Signalling (TPS) bits. The TPS is defined in ETSI EN 300 744 “Digital Video Broadcasting (DVB); Framing structure, channel coding and modulation for digital terrestrial television” V1.4.1 (2001-01).

MPE Encapsulator 6

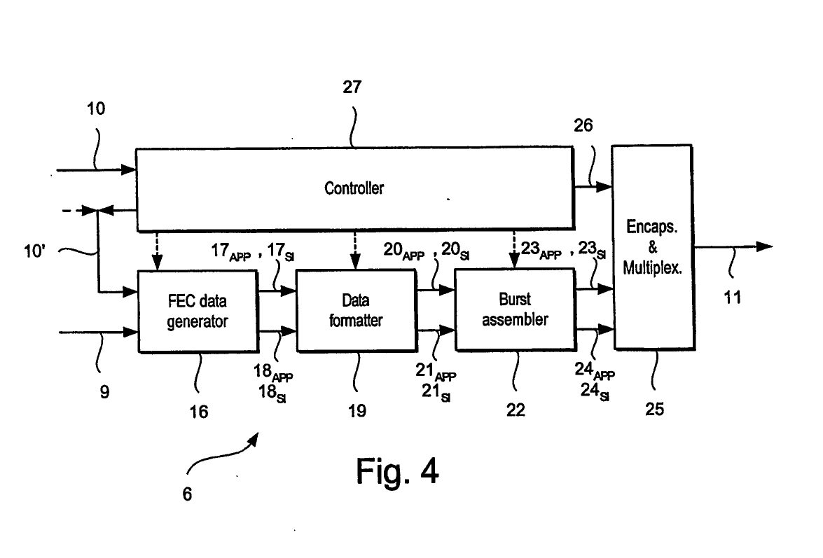

Referring to FIG. 4, the MPE encapsulator 6 is shown in more detail.

The MPE encapsulator 6 receives a stream of data 9 and service information data 10 and, optionally, a copy or partial copy 10′ of service information data 10. The MPE encapsulator 6 comprises means 16 for generating FEC data from the received data 9, 10, 10′. The FEC generating means 16 outputs a stream or set 17_{SI}, of data packets including copied service information data, referred to as “SI data”, and a stream or set 18_{SI} of associated FEC data packets, and a stream or set 17_{APP} of application data packets and a stream or set 18_{APP} of associated FEC data packets.

The MPE encapsulator 6 also comprises means 19 for placing streams or sets 17_{SI}, 17_{APP}, 18_{SI}, 18_{APP} of data packets into sections, in other words data formatting means. The data formatting means 19 outputs corresponding streams or sets of SI sections 20_{SI}, MPE sections 20_{APP}, SI-FEC sections 21_{SI} and MPE-FEC sections 21_{APP}, wherein MPE sections 20_{APP} and MPE-FEC sections 21_{APP} relate to the application data 9.

The MPE encapsulator 6 also comprises means 22 for arranging streams or sets of sections and assembling them into one or more bursts 23_{SI} which comprise SI data, one or more bursts 23_{APP} which comprise application data, one or more bursts 24_{SI} which comprise SI-FEC data and one or more bursts 24_{APP} which comprise MPE-FEC data.

The MPE encapsulator 6 also comprises means 25 for placing sections 20_{SI}, 20_{APP}, 21_{SI}, 21_{APP} which are arranged in time-sliced bursts 23_{SI}, 23_{APP}, 24_{SI}, 24_{APP} and conventional PSI/SI and SI data table sections 26, into transport stream packets and multiplexing transport stream packets into a single transport stream 11.

The MPE encapsulator 6 also comprises controlling means 27. The controlling means 27 or data formatting means 19 may prepare conventional PSI/SI and SI data table sections 26.

In one embodiment of the invention, the MPE encapsulator 6 is implemented by data processing means, such as a personal computer which may include one or more digital signal processors, running one or more computer programs (not shown). However, any element of the MPE encapsulator 6 may be implemented in dedicated hardware which may use a number of microprocessors or digital signal processors. Operation of the MPE encapsulator 6 will now be described in more detail:

FEC Data Generating Means 16

Referring to FIGS. 4, 5 and 6a, the FEC data generating means 16 receives or generates a copy 10′ of service information 10 or a part of service information 10 in the form of a stream or set of PSI/SI and SI data packets 10₁′, 10₂′, 10₃′, 10₄′, 10ₘ′ comprising service information.

The FEC code generating means 16 may also receive a stream or set 9 of application data packets 9₁, 9₂, 9₃, 9₄, 9_{m*} comprising application data, preferably in the form of IP datagrams. It will be appreciated that streams or sets 10′, 9 may comprise different numbers of packets, i.e. m*≠m.

If necessary, PSI/SI and SI data packets 10₁′, 10₂′, 10₃′, 10₄′, 10ₘ′ and/or data packets 9₁, 9₂, 9₃, 9₄, 9_{m*} are pre-processed, for example by arranging the data packets in order and/or dropping selected data packets (step S1).

The FEC generating means 16 generates SI data 17_{SI} and corresponding FEC data 18_{SI} for the SI data packets 10₁′, 10₂′, 10₃′, 10₄′, 10ₘ′ and also application data 17_{APP} and corresponding FEC data 18_{APP} for the data packets 9₁, 9₂, 9₃, 9₄, 9_{m*} (step S2). The process is substantially the same for both types of data packets 10₁′, 10₂′, 10₃′, 10₄′, 10ₘ′, 9₁, 9₂, 9₃, 9₄, 9_{m*}.

The SI data packets 10₁′, 10₂′, 10₃′, 10₄′, 10ₘ′ are stored in a coding table or array 29. The SI data packets 10₁′, 10₂′, 10₃′, 10₄′, 10ₘ′ are stored sequentially in columns 30₁, 30₂, 30₃, 30₄, 30ₘ, 30ₙ in a portion of the table 29 referred to, in this case, as the SI data table 31 which in this case occupies the left-most portion of the table 29.

In this example, one SI data packet 10₁′ occupies one column 30₁. However, one SI data packet 10₁′ may occupy two columns 30₁, 30₂ or any whole number of columns 30₁, 30₂, 30₃, 30₄, 30ₘ, 30ₙ. One SI data packet 10₁′ need not occupy a whole number of columns 30₁, 30₂, 30₃, 30₄, 30ₘ, 30ₙ but may only partially occupy one column 30₁ with the remaining, unoccupied portion of the column being filled with padding bits (not shown) and/or at least part of one or more other SI data packets 10₂′, 10₃′, 10₄′, 10ₘ′. Thus, a SI data packet 10₁′ may be divided between two or more columns 30₁, 30₂. Alternatively, one SI data packet 10₁′ may occupy a whole number of columns 30₁, 30₂ and partially occupy one further column 30₃. The contents of a SI data packet 10₁′, 10₂′, 10₃′, 10₄′, 10ₘ′ can occupy one or more addressable storage locations of one or more columns 30₁, 30₂, 30₃, 30₄, 30ₘ, 30ₙ.

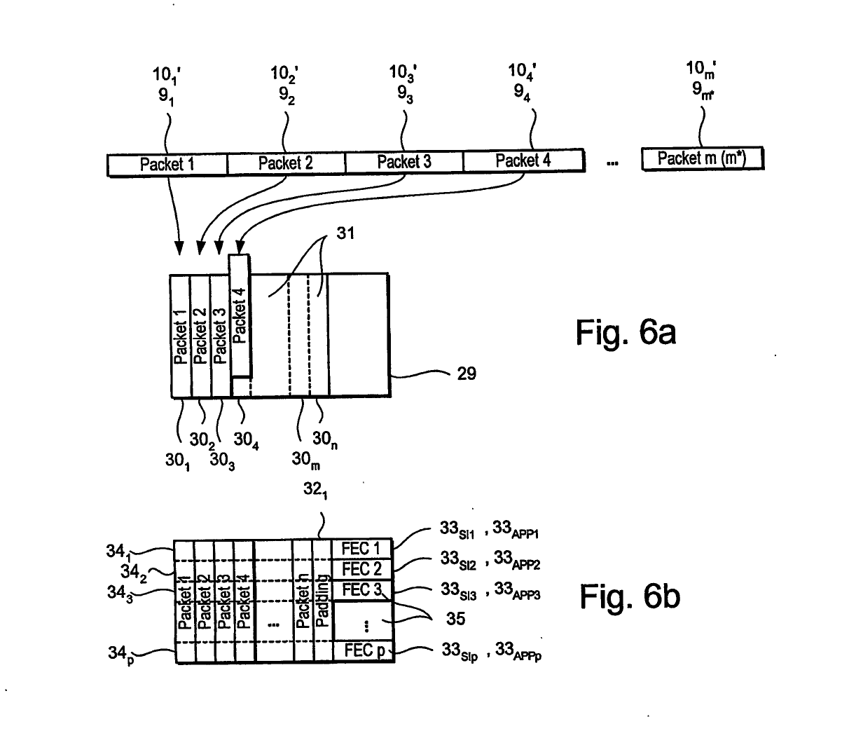

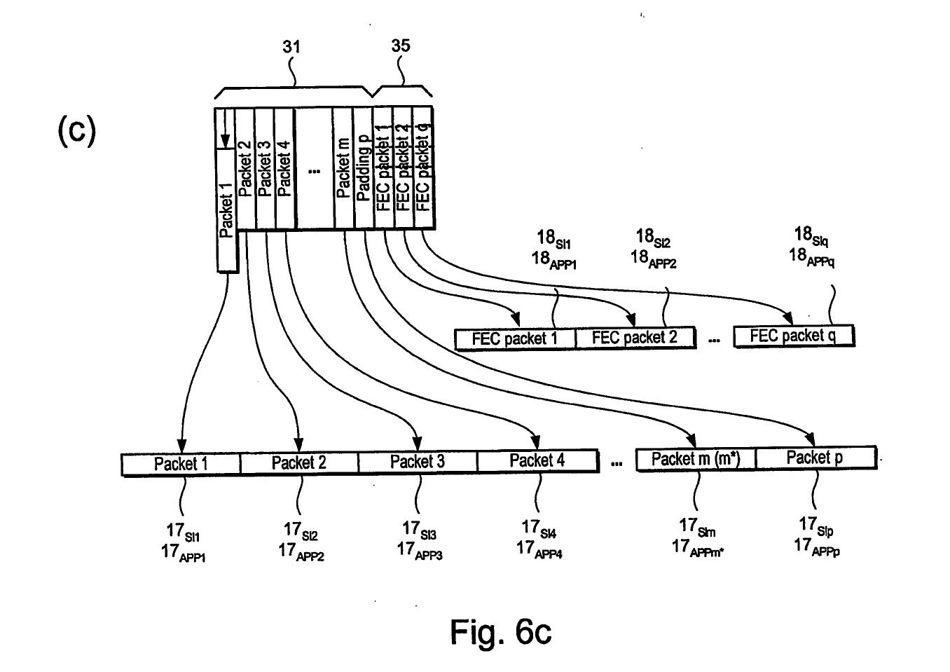

In this example, SI data packets 10₁′, 10₂′, 10₃′, 10₄′, 10ₘ′ only partially fill the SI data table 31. Therefore, any unfilled column 30ₙ is filled with a column's-worth of padding 32₁, for example as shown in FIG. 6b.

Referring to FIG. 6b, once a given number of SI data packets 10₁′, 10₂′, 10₃′, 10₄′, 10ₘ′ have been stored or the SI data table 31 has been filled, FEC row data 33_{SI1}, 33_{SI2}, 33_{SI3}, 33_{SIp} is calculated for each row in table 31. The FEC row data 33_{SI1}, 33_{SI2}, 33_{SI3}, 33_{SIp}, preferably in the form of Reed-Solomon data, is calculated for each row 34₁, 34₂, 34₃, 34ₚ and entered into a portion of the table 29 referred to as the Reed-Solomon data table 35.

In one embodiment of the invention, the coding table 29 has 255 columns. For example, the SI data table 31 may comprise 191 columns and the Reed-Solomon table 35 may comprise 64 columns. Preferably, the SI data table 31 occupies the left-most portion of table 29 and Reed-Solomon table 35 occupies the right-most portion of the table 29. In one embodiment of the invention, the coding table 29 may comprise a selectable number of rows, up to 1024 tows. Preferably, the table 29 comprises one-byte addressable elements. Thus, a table with 255 columns and 1024 rows may store up to 2 Mbits of data.

It will be appreciated that the SI data packets 10₁′, 10₂′, 10₃′, 10₄′, 10ₘ′ may be stored sequentially in rows, wherein the padding is also applied to rows, and FEC column data (not shown) calculated for each column. In other words, rows and columns are interchangeable. It will also be appreciated that the length or size of SI data packets 10₁′, 10₂′, 10₃′, 10₄′, 10ₘ′ can vary. The SI data packets 10₁′, 10₂′, 10₃′, 10₄′, 10ₘ′ may be an uneven size. The padding 32₁ may be omitted when calculating FEC row data 33_{SI1}, 33_{SI2}, 33_{SI3}, 33_{SIp}.

In the case of SI data packets, data within the completed coding table 29 may be referred to as an “SI-FEC frame”.

Referring to FIG. 6c, SI data packets 17_{SI1}, 17_{SI2}, 17_{SI3}, 17_{SI4}, 17_{SIm}, 17_{SIp} and FEC data packets 18_{SI1}, 18_{SI2}, 18_{SIq} are read out of the coding table 29. The FEC data packets 18_{SI1}, 18_{SI2}, 18_{Siq} are read out column by column and so each packet comprises a portion of plural FEC row data 33_{SI1}, 33_{SI2}, 33_{SI3}, 33_{SIp}.

The SI data packets 17_{SI1}, 17_{SI2}, 17_{SI3}, 17_{SI4}, 17_{SIm}, 17_{SIp} can be read out of the table and sent further before the FEC data is calculated. In this case copies of the SI data are left to the table for the FEC calculation. After the FEC calculation and read out of the FEC data packets the table can be emptied.

It will be appreciated that if no stuffing data is used then the SI data packets 17_{SI1}, 17_{SI2}, 17_{SI3}, 17_{SI4}, 17_{SIm}, 17_{SIp} may simply comprise the SI data packets 10₁′, 10₂′, 10₃′, 10₄′, 10ₘ′.

For application data the process is substantially the same. The coding table 29 is filled with data packets 9₁, 9₂, 9₃, 9₄, 9_{m*} in a portion of the table 29 referred to, in this case, as the application data table 31, preferably with one data packet 9₁ occupying one column 30₁, FEC row data 33_{APP1}, 33_{APP2}, 33_{APP3}, 33_{APPp} are calculated for the application data and application data packets 17_{APP1}, 17_{APP2}, 17_{APP3}, 17_{APP4}, 17_{APPm*}, 17_{APPp} and FEC data packets 18_{APP1}, 18_{APP2}, 18_{APPq} are read out of the coding table 29. In the case of application data packets, data within the completed coding table 29 may be referred to as an “MPE-FEC frame”. Also in this case the application data packets 9₁, 9₂, 9₃, 9₄, 9_{m*} can be read out of the table and sent further before the FEC data is calculated. In this case copies of the application data are left to the table for the FEC calculation. After the FEC calculation and read-out of the FEC data packets the table can be emptied.

The process of filling the coding table 29, calculating FEC row data and emptying the coding table 29 can then be repeated for the next set of data 10′, 9, and so on.

In this example, the same coding table 29 is used to process data 10′, 9 which are preferably processed as-and-when required. However, separate coding tables may be provided for each set of data 10′, 9. The coding table 29 may be an allocated portion of memory (not shown).

Data Formatting Means 19

Referring to FIGS. 4, 5, 7 and 8, the data formatting means 19 generates sections 20_{SI} comprising SI data packets 17_{SI1}, 17_{SI2}, 17_{SI3}, 17_{SI4}, 17_{SIm}, 17_{SIp}, sections 20_{APP} comprising application data packets 17_{APP1}, 17_{APP2}, 17_{APP3}, 17_{APP4}, 17_{APPm*}, 17_{APPp}, sections 21_{SI} comprising FEC data packets 18_{SI1}, 18_{SI2}, 18_{SIq} and sections 21_{APP} comprising FEC data packets 18_{APP1}, 18_{APP2}, 18_{APPq} preferably in accordance with Section 7 of European Telecommunications Standards Institute (ETSI) Standard 301 192 “Digital Video Broadcasting (DVB); DVB specification for data broadcasting” V1.3.1 (2003-01) (steps S3 & S4).

Sections 20_{SI} comprising SI data packets 17_{SI1}, 17_{SI2}, 17_{SI3}, 17_{SI4}, 17_{SIm}, 17_{SIp} are hereinafter referred to as “SI sections” and sections 21_{SI} comprising FEC data packets 18_{SI1}, 18_{SI2}, 18_{Siq} associated with the SI data packets 17_{SI1}, 17_{SI2}, 17_{SI3}, 17_{SI4}, 17_{SIm}, 17_{SIp} are referred to as “SI-FEC sections”.

Sections 20_{APP} comprising application data packets 17_{APP1}, 17_{APP2}, 17_{APP3}, 17_{APP4}, 17_{APPm*}, 17_{APPp} are hereinafter referred to as “MPE sections” and sections 21_{APP} comprising FEC data packets 18_{APP1}, 18_{APP2}, 18_{APPq} associated with the application data packets 17_{APP1}, 17_{APP2}, 17_{APP3}, 17_{APP4}, 17_{APPm*}, 17_{APPp} are hereinafter referred to as “MPE-FEC sections”.

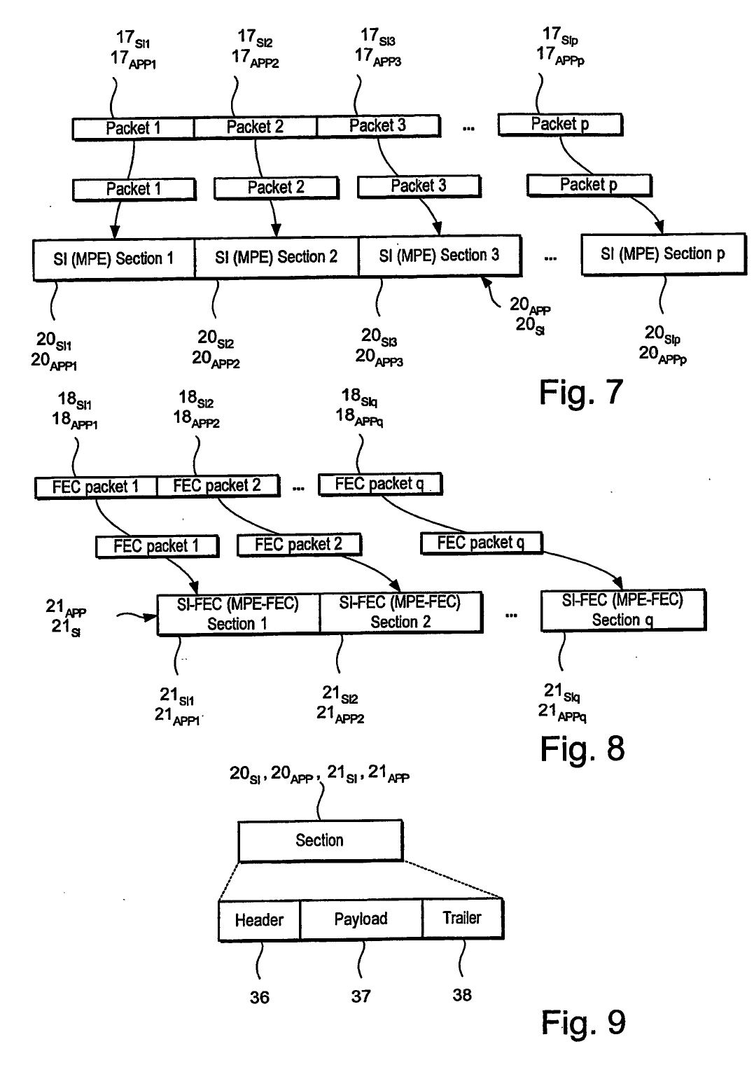

Referring in particular to FIG. 7, the data formatting means 19 places SI data packets 17_{SI1}, 17_{SI2}, 17_{SI3}, 17_{SIp} into SI sections 20_{SI1}, 20_{SI2}, 20_{SI3}, 20_{SIp} compliant with the DSM-CC section format, in one embodiment of the invention, using the syntax defined in Table 1 below:

TABLE 1

| Syntax | No. of bits | Identifier |
|---|---|---|
| datagram_section( ) { | | |
| table_id | 8 | uimsbf |
| section_syntax_indicator | 1 | bslbf |
| private_indicator | 1 | bslbf |
| Reserved | 2 | bslbf |
| section_length | 12 | uimsbf |
| MAC_address_6 | 8 | uimsbf |
| MAC_address_5 | 8 | uimsbf |
| Reserved | 2 | bslbf |
| payload_scrambling_control | 2 | bslbf |
| address_scrambling_control | 2 | bslbf |
| LLC_SNAP_flag | 1 | bslbf |
| current_next_indicator | 1 | bslbf |
| section_number | 8 | uimsbf |
| last_section_number | 8 | uimsbf |
| MAC_address_4 | 8 | uimsbf |
| MAC_address_3 | 8 | uimsbf |
| MAC_address_2 | 8 | uimsbf |
| MAC_address_1 | 8 | uimsbf |
| if (LLC_SNAP_flag == “1”) { | | |

LLC_SNAP( )

| } else { | |
|---|---|
| | for (j=0;j<N1;j++) { |

| | | |
|---|---|---|
| IP_datagram_data_byte | 8 | bslbf |

| | } |
|---|---|
| } | |
| if (section_number == last_section_number) { | |
| | for (j=0;j<N2;j++) { |

| | | |
|---|---|---|
| stuffing_byte | 8 | bslbf |

| | } | | |
|---|---|---|---|
| } | | | |
| if (section_syntax_indicator ==“0”) { | | | |
| | Checksum | 32 | uimsbf |
| } else { | | | |
| | CRC_32 | 32 | rpchof |

}
}

In one embodiment of the invention, each SI data packet 17_{SI1}, 17_{SI2}, 17_{SI3}, 17_{SIp} is placed in a corresponding SI section 20_{SI1}, 20_{SI2}, 20_{SI3}, 20_{SIn}.

Likewise, the data formatting means 19 places application data packets 17_{APP1}, 17_{APP2}, 17_{APP3}, 17_{APPp} into MPE sections 20_{APP1}, 20_{APP2}, 20_{APP3}, 20_{APPp} compliant with the DSM-CC section format, using the syntax defined in Table 1 above and in one embodiment of the invention each application data packet 17_{APP1}, 17_{APP2}, 17_{APP3}, 17_{APPp} is placed into a corresponding MPE section 20_{APP1}, 20_{APP2}, 20_{APP3}, 20_{APPn}.

Referring in particular to FIG. 8, the data formatting means 19 places FEC data packets 18_{SI1}, 18_{SI2}, 18_{SIq} for SI data packets into SI-FEC sections 21_{SI1}, 21_{SI2}, 21_{SIq} compliant with the DSM-CC section format, in one embodiment of the invention using the syntax defined in Table 2 below:

TABLE 2

| | | |
|---|---|---|
| Syntax | No. of bits | Identifier |

FEC_section ( ) {

| | | |
|---|---|---|
| table_id | 8 | uimsbf |
| section_syntax_indicator | 1 | bslbf |
| reserved_for_future_use | 1 | bslbf |
| Reserved | 2 | bslbf |
| section_length | 12 | uimsbf |
| padding_columns | 8 | uimsbf |
| reserved_for_future_use | 8 | bslbf |
| Reserved | 2 | bslbf |
| reserved_for_future_use | 5 | bslbf |
| current_nect_indicator | 1 | bslbf |
| section_number | 8 | uimsbf |
| last_section_number | 8 | uimsbf |
| real_time_parameters( ) | | |
| for( i=0; I<N; i++ ) { | | |

| | | |
|---|---|---|
| rs_data_byte | 8 | uimsbf |

| } | | |
|---|---|---|
| CRC_32 | 32 | uimsbf |

}

In one embodiment of the invention, each FEC data packet 18_{SI1}, 18_{SI2}, 18_{SIq} is placed in a corresponding SI-FEC section 21_{SI1}, 21_{SI2}, 21_{SIq}.

Likewise, the data formatting means 19 places FEC data packets 18_{APP1}, 18_{APP2}, 18_{APPq} for application data into MPE-FEC sections 21_{APP1}, 21_{APP2}, 21_{APPq} compliant with the DSM-CC section format, using the syntax defined in Table 2 above and in one embodiment of the invention each FEC data packet 18_{APP1}, 18_{APP2}, 18_{APPq} is placed into a corresponding MPE-FEC section 21_{APP1}, 21_{APP2}, 21_{APPq}.

Referring to FIG. 9, the general structure of an SI section 20_{SI}, an MPE section 20_{APP}, an SI-FEC section 21_{SI} and an MPE-FEC section 21_{APP} is shown. The section 20_{SI}, 20_{APP}, 21_{SI}, 21_{APP} comprises a header 36, a payload 37 and an optional trailer 38. For an SI section 20_{SI1}, 20_{SI2}, 20_{SI3}, 20_{Spn}, the payload 37 includes an SI data packet 17_{SI1}, 17_{SI2}, 17_{SI3}, 17_{SIp} (FIG. 7). For an SI-FEC section 21_{SI1}, 21_{SI2}, 21_{SIq}, the payload 37 includes a FEC data packet 18_{SI1}, 18_{SI2}, 18_{SIq} (FIG. 8).

Burst Assembling Means 22

Time slicing may be employed whereby, instead of transmitting data for a service at a bit rate appropriate for consuming the transmitted service, for example which would allow direct rendering or other use of the application data for the service, the data for the service is sent in one or more bursts using a higher bit rate. Preferably, all the available bandwidth is used. Between bursts, no application data for the said service is transmitted. Thus, the bandwidth can be used for other services.

Time slicing has advantages. For example, a receiver can be switched off between bursts, thereby saving power. Also, the receiver can monitor transmissions in neighbouring cells between bursts so that the receiver can make a handover if necessary seemingly without interruption.

As will be explained in more detail later, receivers are notified that time slicing and other schemes are being used through a network information table (NIT) or through an IP/MAC Notification Table (INT).

Once notified that time slicing is being used, receivers can switch off between bursts. However, in order to do so, they need information regarding when to expect bursts. This can be achieved by including, in each burst, information on the time until the beginning of the next burst, which is referred to as “delta-t”. In one embodiment of the invention, delta-t is defined as the time from the end of one burst to the beginning of the next burst. In another embodiments of the invention, delta-t may be defined as the time from the beginning of one burst to the beginning of the next burst or a time from the end of one burst to the end of the next burst. In yet another embodiment of the invention, delta-t information may be given in one or more sections within a burst and delta-t is defined as the time from the beginning of the section to the beginning of the next burst. Preferably, no bursts for the service will be transmitted within the announced duration of delta-t. Other information about bursts can also be included and is referred to as “real-time parameters”.

In an embodiment of the present invention, SI sections 20_{SI} carrying SI data 17_{SI} are assembled into a first set of bursts 23_{SI} (only one shown) and SI-FEC sections 21_{SI}, carrying FEC data 18_{SI} for the SI data are assembled into a second, different set of bursts 24_{SI}. Likewise, MPE sections 20_{APP} carrying application data 17_{APP} are assembled into a third set of bursts 23_{APP} (only one shown) and MPE-FEC sections 21_{APP} carrying FEC data 18_{APP} for the application data are assembled into a fourth, different set of bursts 24_{APP} (only one shown). A set of bursts may comprise one or more bursts.

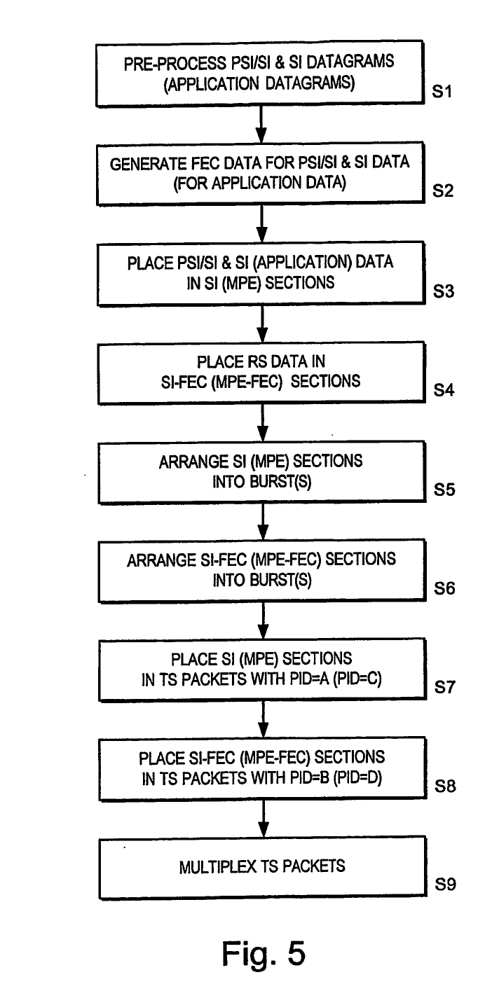

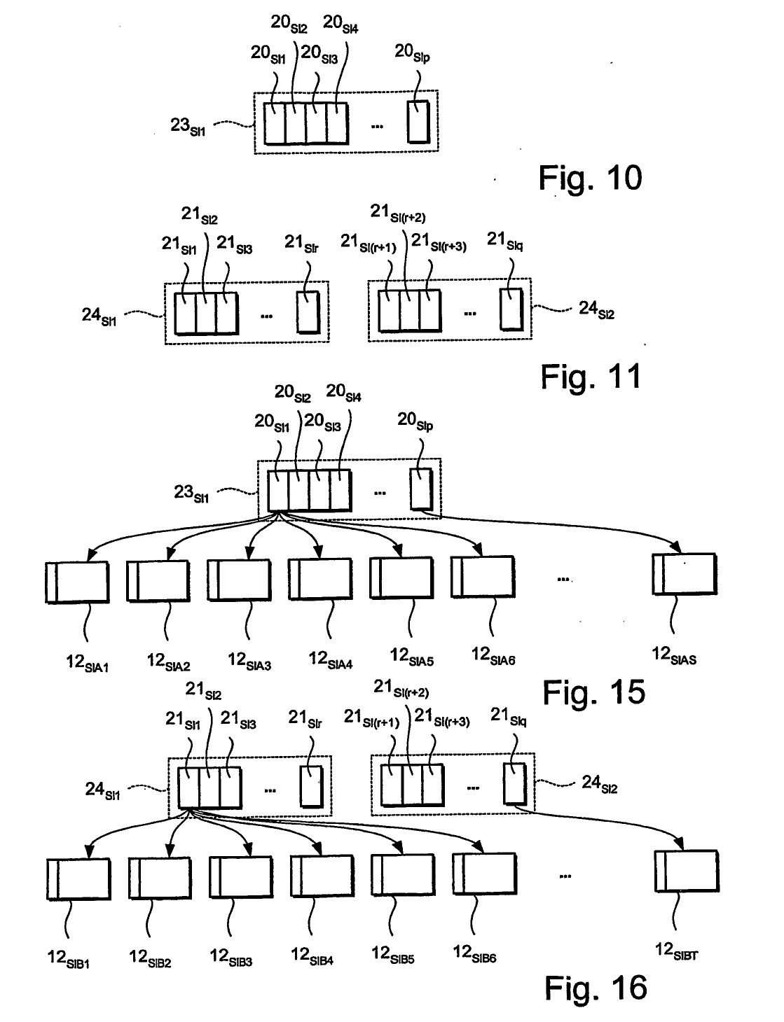

Referring still to FIGS. 4 and 5 and also to FIGS. 10 and 11, the burst assembling means 22 arranges the SI sections 20_{SI1}, 20_{SI2}, 20_{SI3}, 20_{SI4}, 20_{SIp} into an SI burst 23_{SI1} (step S5). SI sections 20_{SI1}, 20_{SI2}, 20_{SI3}, 20_{SI4}, 20_{SIp} may be divided between plural bursts.

The burst assembling means 22 also arranges SI-FEC sections 21_{SI1}, 21_{SI2}, 21_{SI3}, 21_{SIr} and SI-FEC sections 21_{SI(r+1)}, 21_{SI(r+2)}, 21_{SI(r+3)}, 21_{SIq} into first and second FEC bursts 24_{SI1}, 24_{SI2} respectively (step S6).

Alternatively, SI-FEC section 21_{SI1}, 21_{SI2}, 21_{SIq} may be assembled into a single burst or three or more bursts.

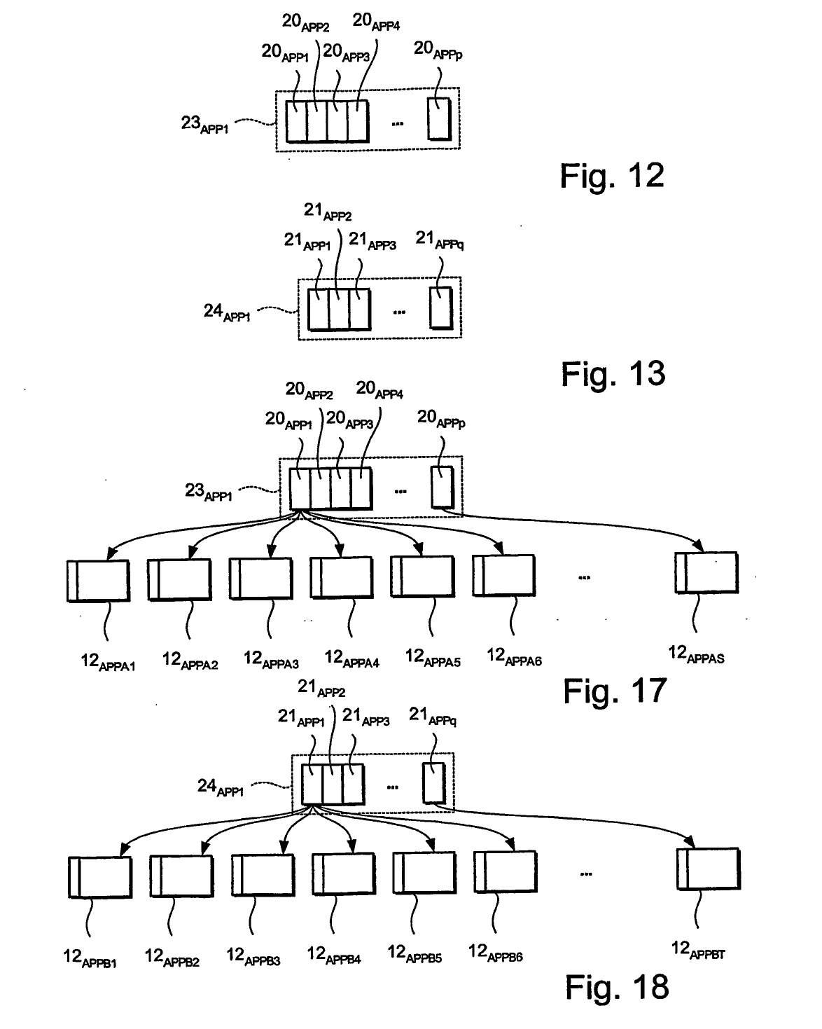

Referring still to FIGS. 4 and 5 and also to FIGS. 12 and 13, the burst assembling means 22 arranges the MPE sections 20_{APP1}, 20_{APP2}, 20_{APP3}, 20_{APP4}, 20_{APPp} into an MPE burst 23_{APP1} (step S5). MPE sections 20_{APP1}, 20_{APP2}, 20_{APP3}, 20_{APP4}, 20_{APPp} may be divided between plural bursts.

The burst assembling means 22 arranges the MPE-FEC section 21_{APP1}, 21_{APP2}, 21_{APP3}, 21_{APPq} into an MPE-FEC burst 24_{APP1} (step S6). MPE-FEC sections 21_{APP1}, 21_{APP2}, 21_{APP3}, 21_{APPq} may be divided between plural bursts.

The burst assembling means 22 places respective real time parameters in MAC_address_{—}1 to MAC address_{—}4 fields of each header 36 (FIG. 9) as defined in Table 1 or 2 above of each SI section 20_{SI1}, 20_{SI2}, 20_{SI3}, 20_{SIp}, each MPE section 20_{APP1}, 20_{APP2}, 20_{APP3}, 20_{APPp}, each SI-FEC sections 21_{SI1}, 21_{SI2}, 21_{SIq} and each MPE-FEC sections 21_{APP1}, 21_{APP2}, 21_{APPq}. For example, Table 3 below shows real time parameter syntax in one embodiment of the invention:

TABLE 3

| | | |
|---|---|---|
| Syntax | No. of bits | Identifier |

realtime_parameters( ) {

| | | |
|---|---|---|
| delta_t | 12 | uimsbf |
| table_boundary | 1 | bslbf |
| burst_boundary | 1 | bslbf |
| Address | 18 | uimsbf |

}

Referring FIGS. 4, 10 and 14 and taking the example of the SI burst 23_{SI1}, the delta_t field indicates the time from the beginning of one section within the burst to the beginning of the next SI burst 23_{SI2}. In this embodiment of the invention, a value of delta-t is included in all SI sections 20_{SI1}, 20_{SI2}, 20_{SI3}, 20_{SIp} within the burst 23_{SI1} and so the value may differ from section to section. Thus, for the first section 20_{SI1} the value is delta_t_{SIA} and for a later section 20_{SI2}, 20_{SI3}, 20_{SIp} the value is delta_t_{SIA′}, wherein delta_t_{SIA}>delta_t_{SIA′}.

In one embodiment of the invention, resolution of the delta-t is 10 ms. For example, a value 0xC00 (in hexadecimal)=3072 (in decimal) indicates that the time to the beginning of next burst is 30.72 s. The value 0x00 is reserved to indicate that no more bursts will be transmitted within the elementary stream, in other word to indicate end of service. In such a case, all SI sections 20_{SI1}, 20_{SI2}, 20_{SI3}, 20_{SIp} within the burst 23_{SI1} have the same value in this field.

Further in one embodiment of the invention, delta-t is defined from the TS packet 12_{SIA1} (FIG. 15) carrying the first byte of the current SI section 20_{SI1}, 20_{SI2}, 20_{SI3}, 20_{SI4}, 20_{SIp} to the TS packet (not shown) carrying the first byte of next burst 23_{SI2}.

Therefore, the value of delta-t can differ between MPE sections 20_{SI1}, 20_{SI2}, 20_{SI3}, 20_{SI4}, 20_{SIp} within the burst 23_{SI1}.

The time indicated by delta-t may be beyond the end of the maximum burst duration of the actual burst. This helps to ensure that a decoder can reliably distinguish two sequential bursts within an elementary stream.

In one embodiment of the invention, all the SI sections 20_{SI1}, 20_{SI2}, 20_{SI3}, 20_{SI4}, 20_{SIp} comprising all the SI data 17_{SI1}, 17_{SI2}, 17_{SI3}, 17_{SIm}, 17_{SIp} (FIG. 6c) from the SI data table 31 (FIG. 6c) is comprised in the application burst 23_{SI1} and not divided between plural application bursts. Furthermore, it is preferable that the burst 23_{SI1}, contains complete SI data packets 17_{SI1}, 17_{SI2}, 17_{SI3}, 17_{SI4}, 17_{SIm}, 17_{SIp}, i.e. that data packets are not fragmented between bursts. Also, transmission of empty SI sections, i.e. an SI section with no payload, is preferably to be avoided.

Each SI burst 23_{SI1} may contains at least one SI section 20_{SI1}, 20_{SI2}, 20_{SI3}, 20_{SIm}, 20_{SIp} carrying a proper data packet containing a network layer address (not shown), which is one of the addresses an IP/MAC Notification Table (INT) has associated with the elementary stream.

In Table 3 above, the table_boundary field is a flag. When the flag is set to “1”, it indicates that the current section is the last section of the table 31 (FIG. 6c). In the case of SI section this flag indicates the last section of the SI table. In the case of SI-FEC section this flag indicates the last section of the corresponding RS data table.

In another embodiment of the present invention, SI sections 20_{SI1}, 20_{SI2}, 20_{SI3}, 20_{SI4}, 20_{SIp} and SI-FEC sections 21_{SI1}, 21_{SI2}, 21_{SIq} comprised in a single SI-FEC frame 29 (FIG. 6a) may be transmitted using TS packets having the same PID, which may or may not be time sliced. Under these circumstances, a decoder (not shown) receiving an SI-FEC frame 29 but not supporting SI-FEC (i.e. the system of transferring SI data and associated FEC data) may ignore all subsequent sections until the end of the SI-FEC frame 29, which is indicated using burst_boundary field. For each SI-FEC frame 29, one SI section 20_{SI1}, 20_{SI2}, 20_{SI3}, 20_{SIm}, 20_{Sip} is transmitted with this flag set. For each SI-FEC frame 29 in which RS data is transmitted, one SI-FEC section 21_{SI1}, 21_{SI2}, 21_{SIq} is transmitted with this flag set. If SI-FEC is not supported on the elementary stream, the flag is reserved for future use. When not used, the flag is set to “0”.

In Table 3 above, the burst_boundary field is a flag. When the flag is set to “1”, it indicates that the current section is the last section within the current burst. For each SI burst 23_{SI1}, one SI section 20_{SI1}, 20_{SI2}, 20_{SI3}, 20_{SIm}, 20_{Sip} is transmitted with this flag set. For each SI-FEC frame 29, one SI or SI-FEC section 20_{SI1}, 20_{SI2}, 20_{SI3}, 20_{SIm}, 20_{Sip}, 21_{SI1}, 21_{SI2}, 21_{SIq} is transmitted with this flag set.

The address field specifies the position, in the corresponding table 29 (FIG. 6a), of the first byte of the payload carried within the SI section 20_{SI1}, 20_{SI2}, 20_{SI3}, 20_{SIm}, 20_{SIp}. All sections delivering data for a table 29 are delivered in ascending order according to the value of this field. The bytes position is a zero-based linear address within the table 29, starting from the first row of the first column, and increasing towards the end of the column. At the end of the column, the next byte position is at the first row of the next column. Thus, the address field of the first SI section 20_{SI1} of the table 29 contains the value “0” and addressing starts from zero for each table 29.

In another embodiment of the present invention mentioned earlier, the first section carrying data of a given SI-FEC frame 29 is an SI section carrying the SI data datagram at address “0”. All sections 20_{SI1}, 20_{SI2}, 20_{SI3}, 20_{SIm}, 20_{SIp} carrying SI data packets of a given SI-FEC frame 29 are transmitted prior to the first section 21_{SI1}, carrying RS-data packets of the SI-FEC frame 29. In other words, sections 20_{SI1}, 20_{SI2}, 20_{SI3}, 20_{SIm}, 20_{SIp} carrying SI data are not interleaved with sections 21_{SI1}, 21_{SI2}, 21_{SIq} carrying RS-data within a single SI-FEC frame 29. All sections carried between the first section 20_{SI1} and the last section 21_{SIq} of an SI-FEC frame 29 carry data belonging to the SI-FEC frame 29, i.e. only SI (application) data 31 and RS data 35 is used. Sections delivering data of different SI-FEC frames are not interleaved. In another embodiment of the present invention mentioned earlier, the section following the last section carrying SI data packet on an SI-FEC frame 29 contains either the first section carrying the RS-data of the same SI-FEC frame or the first application data section of the next SI-FEC frame. In the latter case, RS-data of the first SI-FEC frame is not transmitted. For each SI-FEC frame 29, one SI section is transmitted with the address field set to “0”. For each SI-FEC frame 29 in which any RS data is transmitted, one SI-FEC section is transmitted with the address field set to “0”. Padding is not used within delivered SI data in the SI data table 31 (FIG. 6c). Packets do not overlap in an SI data table 31 (FIG. 6c). Padding is not used within delivered RS data in the RS table 35 (FIG. 6c).

Addressing starts from zero within each SI-FEC frame 29. If both time slicing and SI-FEC are used on an elementary stream, each burst on the elementary stream contains exactly one SI-FEC frame 29. In other words, the SI-FEC frame 29 is not split over multiple bursts. If SI-FEC is not supported on the elementary stream, the address field is reserved for future use. When not used, the address field is set to 0x00.

In one embodiment of the present invention, SI sections 20_{SI1}, 20_{SI2}, 20_{SI3}, 20_{SIm}, 20_{Sip} and SI-FEC sections 21_{SI1}, 21_{SI2}, 21_{SIq} are transmitted separately. For the SI-FEC burst 24_{SI1}, the delta_t field indicates the time to the next SI-FEC burst 24_{SI2}. Preferably, a value of delta-t is included in all SI-FEC sections 21_{SI1}, 21_{SI2}, 21_{SIq} within the burst 24_{SI1} and so the value may differ from section to section. Thus, for the first section 21_{SI1} the value is delta_t_{B} and for a later section 21_{SI2}, 21_{SIq} the value is delta_t_{B′}, wherein delta_t_{B}>delta_t_{B′}.

Referring FIGS. 4, 10 and 15, similar to the SI burst 23_{SI1} described earlier, the SI-FEC burst 24_{SI1} includes table_boundary field, the burst_boundary field and the address fields. However, because two FEC bursts 24_{SI1}, 24_{SI2} are used, the burst_boundary field is employed to indicate whether the current section is the last section within the RS table 35 (FIG. 6c).

Referring FIGS. 4, 10, 16 and 17, each MPE section 20_{APP1}, 20_{APP2}, 20_{APP3}, 20_{APPp} and each MPE-FEC section 21_{APP1}, 21_{APP2}, 21_{APPq} also include real time parameters.

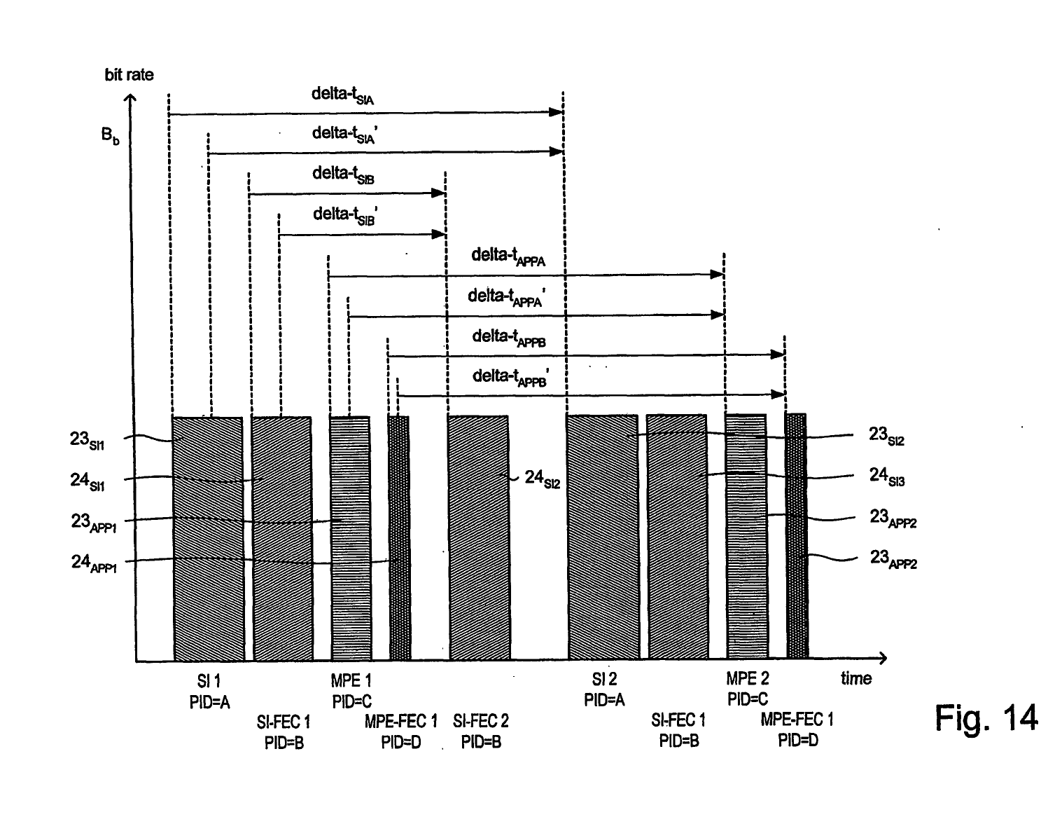

Referring to FIG. 14 and taking the example of the MPE burst 23_{APP1}, in one embodiment of the present invention the delta_t field indicates the time from the beginning of one section to the beginning of the next MPE burst 23_{MPE2}. Preferably, a value of delta-t is included in all MPE sections 20_{APP1}, 20_{APP2}, 20_{APP3}, 20_{APPp} within the burst 23_{APP1} and so the value may differ from section to section. Thus, for the first section 20_{APP1} the value is delta_t_{APPA} and for a later section 20_{APP2}, 20_{APP3}, 20_{APPp} the value is delta_t_{APPA′}, wherein delta_t_{APPA}>delta_t_{APPA′}.

Likewise, for the MPE-FEC burst 24_{APP1}, in one embodiment of the invention, the delta_t field indicates the time from the beginning of one section to the beginning of the next MPE-FEC burst 24_{APP2}. Preferably, a value of delta-t is included in all MPE-FEC sections 21_{APP1}, 21_{APP2}, 21_{APPq} within the burst 24_{APP1} and so the value may differ from section to section. Thus, for the first section 21_{APP1} the value is delta_t_{APPB} and for a later section 21_{APP2}, 21_{APPq} the value is delta_t_{APPB′}, wherein delta_t_{APPB}>delta_t_{APPB′}.

Encapsulating and Multiplexing Means 25

Referring to FIGS. 4, 5, 15 and 16, the encapsulating and multiplexing means 25 places SI sections 20_{SI1}, 20_{SI2}, 20_{SI3}, 20_{SI4}, 20_{SIp} into TS packets 12_{SIA1}, 12_{SIA2}, 12_{SIA3}, 12_{SIA4}, 12_{SIA5}, 12_{SIA6}, 12_{SIAS} having the same PID, for example PID=A, where A is hexadecimal number between 0x0030 to 0x1FFE (step S7).

The encapsulating and multiplexing means 25 places SI-FEC sections 21_{SI1}, 21_{SI2}, 21_{SI3}, 21_{SIr}, 21_{SI(r+1)}, 21_{SI(r+2)}, 21_{SI(r+3)}, 21_{SIq} into TS packets 12_{SIB1}, 12_{SIB2}, 12_{SIB3}, 12_{SIB4}, 12_{SIB5}, 12_{SIB6}, 12_{SIBT} having the same PID, for example PID=B, where B is hexadecimal number between 0x0030 to 0x1FFE (step S7). In one embodiment of the present invention, PID A and PID B are different (A≠B).

Referring to FIGS. 4, 5, 17 and 18, the encapsulating and multiplexing means 25 places MPE sections 20_{APP1}, 20_{APP2}, 20_{APP3}, 20_{APP4}, 20_{APPn} into TS packets 12_{APPA1}, 12_{APPA2}, 12_{APPA3}, 12_{APPA4}, 12_{APPA5}, 12_{APPA6}, 12_{APPAS} having the same PID, for example PID=C, where C is hexadecimal number between 0x0030 to 0x1FFE. In one embodiment of the invention, PID A and PID C are different (A≠C).

The encapsulating and multiplexing means 25 places MPE-FEC sections 21_{APP1}, 21_{APP2}, 21_{APP3}, 21_{APPr}, 21_{APP(r+1)}, 21_{APP(r+2)}, 21_{APP(r+3)}, 21_{APPq} into TS packets 12_{APPB1}, 12_{APPB2}, 12_{APPB3}, 12_{APPB4}, 12_{APPB5}, 12_{APPB6}, 12_{APPBT} having the same PID, for example PID=D, where D is hexadecimal number between 0x0030 to 0x1FFE (step S7). In one embodiment of the present invention, PID C and PID D are different (C≠D).

In this example, each SI section 20_{SI}, SI-FEC section 21_{SI}, MPE section 20_{MPE}, MPE-FEC section 21_{MPE}, is divided between six TS packets 12. However, a fewer or greater number of TS packets 12 may be used to carry one SI section 20_{SI}, SI-FEC section 21_{SI}, MPE section 20_{APP}, MPE-FEC section 21_{APP}.

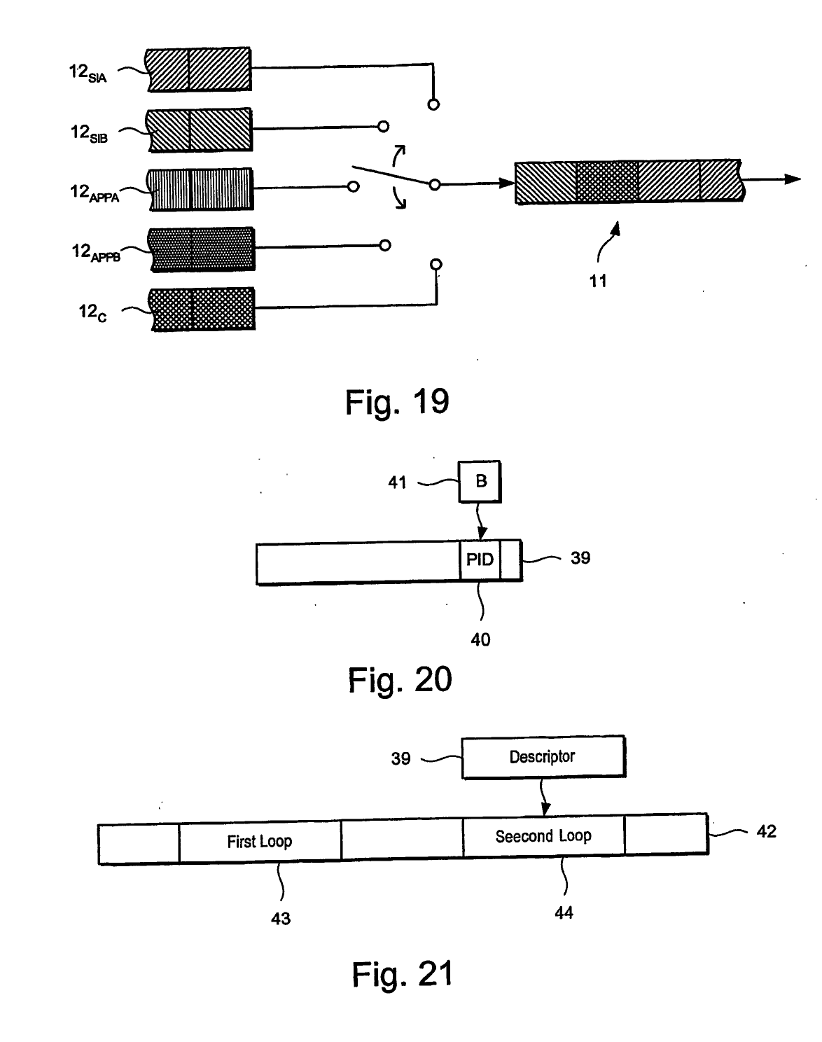

Referring to FIG. 19, TS packets 12_{SIA} carrying SI data, TS packets 12_{SIB} carrying SI-FEC data, TS packets 12_{APPA} carrying application data, TS packets 12_{APPB} carrying MPE-FEC data and TS packets 12_{C} carrying other data are multiplexed to form a single stream 11. TS packets 12 comprised in a single burst are transmitted as a contiguous stream.

Referring again to FIG. 14, the SI burst 23_{SI1} is transmitted followed by SI-FEC bursts 24_{SI1}, 24_{SI2}. Thus, all the SI-FEC data 18_{SI1}, 18_{SI2}, 18_{SIq} (FIG. 6c) for an SI-FEC frame 29 is transmitted before SI data for the next SI-FEC frame is transmitted.

Likewise, the MPE burst 23_{APP1} is transmitted followed by the MPE-FEC burst 24_{APP1}. Thus, all the MPE-FEC data 18_{APP1}, 18_{APP2}, 18_{APPq} (FIG. 6c) for an MPE-FEC frame 29 is transmitted before application data for the next MPE-FEC frame is transmitted.

However, SI burst 23_{SI1} may be transmitted before or after the MPE burst 23_{APP1}. In another embodiment of the present invention mentioned earlier, SI sections 20_{SI1}, 20_{SI2}, 20_{SI3}, 20_{SIm}, 20_{Sip} and SI-FEC sections 21_{SI1}, 21_{SI2}, 21_{SIq} comprised in a single SI-FEC frame 29 (FIG. 6a) may be transmitted using TS packets having the same PID

In yet another embodiment of the invention, the SI bursts 23_{SI1}, 23_{SI2} and SI-FEC bursts 24_{SI1}, 24_{SI2} are generated as described earlier. However, the encapsulating and multiplexing means 25 places the SI-FEC sections 21_{SI1}, 21_{SI2}, 21_{SI3}, 21_{SIr}, 21_{SI(r+1)}, 21_{SI(r+2)}, 21_{SI(r+3)}, 21_{SIq} into TS packets 12_{SIB1}, 12_{SIB2}, 12_{SIB3}, 12_{SIB4}, 12_{SIB5}, 12_{SIB6}, 12_{SIBT} having the same PID as the TS packets 12_{SIA1}, 12_{SIA2}, 12_{SIA3}, 12_{SIA4}, 12_{SIA5}, 12_{SIA6}, 12_{SIAT} carrying SI data sections 20_{SI1}, 20_{SI2}, 20_{SI3}, 20_{SI4}, 20_{SIn}, in other words the same PID is used for both bursts (A=B).

Controlling Means 27

Referring to FIG. 4, the MPE encapsulator 6 generally processes PSI/SI and SI data 10 in two ways:

Firstly, the MPE encapsulator 6 receives, modifies and/or prepares PSI/SI and SI data 10 and conventionally transmits the data 10 to receivers, in other words without any FEC data.

Secondly, the MPE encapsulator 6 receives, modifies and/or prepares PSI/SI and SI data 10, makes a copy 10′, generates FEC data and transmits the data 10′ together with FEC data optionally using time slicing.

Each of these processes will now be described in more detail:

—PSI/SI and SI Data 10—

The controlling means 27 receives an IP/MAC Notification Table (INT) (not shown) or part of the INT as part of the service information data 10 (FIG. 2). The INT is used to signal the PID of the TS packets 12_{SIA1} (FIG. 15) carrying SI data. In other words, the INT is used to signal the availability and location of the elementary stream with PID=A.

The controlling means 27 segments service information tables including the INT into sections (not shown) and passes the table sections 26 (FIG. 4) to the encapsulating and multiplexing means 25 to be mapped into TS packets (not shown) having PID=0x004C and multiplexed into the transport stream 11 (FIG. 2).

The INT is described in more detail in Sections 7.6 of ETSI EN 301 192 “Digital Video Broadcasting (DVB); DVB specification for data broadcasting” V1.2.1 (2003-01).

As briefly mentioned earlier, a data broadcast descriptor in a Service Description Table (SDT) transmitted using service description sections indicates that MAC_address 1 to MAC_address 4 fields are not being used to differentiate receivers within an elementary stream but are being used to carry real time parameters, such as delta-t.

The service description sections and data broadcast descriptor is described in more detail in Sections 6 and 7 of ETSI EN 300 468 “Digital Video Broadcasting (DVB); Specification for Service Information (SI) in DVB systems” V1.5.1 (2003-01).

Referring to FIG. 20, a time slice identifier descriptor 39 is shown. In one embodiment of the invention, the syntax of the time slice identifier descriptor 39 is given in Table 4 below:

TABLE 4

| Syntax | | No. of bits | Identifier |
|---|---|---|---|
| Time_slice_fec_identifier_descriptor ( ){ | | | |
| | descriptor_tag | 8 | uimsbf |
| | descriptor_length | 8 | uimsbf |
| | time_slicing | 1 | bslbf |
| | si_fec/mpe_fec | 1 | uimsbf |
| | reserved_for_future_use | 1 | uimsbf |
| | data_padding_columns | 8 | uimsbf |
| | max_burst_duration | 4 | uimsbf |
| | max_frame size | 4 | uimsbf |
| | si-fec/mpe_fec PID | 13 | uimsbf |

}

According to Table 4 above, the descriptor_tag field is provided with a value agreed specified by a standards organisation. The descriptor_length field specifies the number of bytes immediately following the field. The time_slicing field indicates, whether the elementary stream in question is time sliced. A value “1” indicates that time slicing is being used, while a value “0” indicates that time slicing is not used. The mpe_fec/si_fec field indicates whether the elementary stream uses SI-FEC and MPE-FEC.

The data_padding_columns field specifies the fixed number of padding columns 32₁ (FIG. 6b) that are introduced immediately before the end of the application data table 31 (FIG. 6b). In one embodiment of the invention the number of padding columns can take a value between 0 and 190. If the si_fec/mpe_fec field is set to “0” then the content of the field is ignored.

The max_burst_duration field is used to indicate the maximum burst duration in the concerned elementary stream. A burst does not start before T₁ and does not end later than T₂, where T₁ is the time indicated by delta-t on a previous burst, and T₂=T₁+maximum burst duration. In one embodiment of the present invention, the indicated value for maximum burst duration preferably lies within a range from 20 ms to 512 s in 20 ms steps. The maximum burst duration=max_burst_duration×20 milliseconds. In one embodiment of the present invention, the max_burst_duration field is encoded according to Table 5 below:

TABLE 5

| Duration | Description | |
|---|---|---|
| 0000 | 100 | ms |
| 0001 | 125 | ms |
| 0010 | 150 | ms |
| 0011 | 200 | ms |
| 0100 | 250 | ms |
| 0101 | 300 | ms |
| 0110 | 350 | ms |
| 0111 | 400 | ms |
| 1000 | 500 | ms |
| 1001 | 600 | ms |
| 1010 | 800 | ms |
| 1011 | 1100 | ms |
| 1100 | 1500 | ms |
| 1101 | 2000 | ms |
| 1110 | 3000 | ms |
| 1111 | 5000 | ms |

The frame_size field is used to give information that a decoder may use to adapt its buffering usage. The exact interpretation depends on whether time slicing and/or SI-FEC and MPE-FEC are used.

If the time_slicing field is set to “0”, i.e. time slicing is not used, then the frame_size field is reserved for future use and is set to 0x00 when not used. If the time_slicing field is set to “1”, i.e. time slicing is used, then the frame_size field indicates the maximum number of bits on section level allowed within a time slice burst on the elementary stream. Bits are calculated from the beginning of the table_id field to the end of the CRC_{—}32 field.

If the si_fec/mpe_fec field is set to “1”, i.e. SI-FEC and/or MPE-FEC is used, then this field indicates the exact number of rows on each SI-FEC frame (or MPE-FEC frame) on the elementary stream. When both time slicing and SI-FEC and/or MPE-FEC are used on the elementary stream, both limitations (i.e. the maximum burst size and the number of rows) apply. In one embodiment of the present invention, frame_size field may be coded according to Table 6 below:

TABLE 6

| Size | Max Burst size | | MPE-FEC frame rows |
|---|---|---|---|
| 0x00 | 128 | kbits | 64 |
| 0x01 | 256 | kbits | 128 |
| 0x02 | 384 | kbits | 192 |
| 0x03 | 512 | kbits | 256 |
| 0x04 | 640 | kbits | 320 |
| 0x05 | 768 | kbits | 384 |
| 0x06 | 896 | kbits | 448 |
| 0x07 | 1 024 | kbits | 512 |
| 0x08 | 1 152 | kbits | 576 |
| 0x09 | 1 280 | kbits | 640 |
| 0x0A | 1 408 | kbits | 704 |
| 0x0B | 1 536 | kbits | 768 |
| 0x0C | 1 664 | kbits | 832 |
| 0x0D | 1 792 | kbits | 896 |
| 0x0E | 1 920 | kbits | 960 |
| 0x0F | 2 048 | kbits | 1024 |

| | | |
|---|---|---|
| 0x10 to 0x1F | Reserved for future use | Reserved for future use |

If the max_frame_size field indicates “reserved_for_future_use”, the receiver assumes that the maximum burst size is greater than 2 Mbits and MPE-FEC frame rows more than 1024.

In one embodiment of the present invention, time slicing is not used, i.e. SI-FEC frames (or MPE-FEC frames) are transmitted without any time slicing, and a field that supports a cyclic SI-FEC frame index (MPE-FEC frame index) within the elementary stream can be used for control purposes. The value of the field increases by one for each subsequent MPE-FEC frame. After value “111111111111”, the field restarts from “000000000000”.

The si_fec/mpe_fec PID field 40 specifies the PID of the elementary stream used to transmit SI-FEC data 18_{SI1}, 18_{SI2}, 18_{SIq} or MPE-FEC data 18_{APP1}, 18_{APP2}, 18_{APPq} of the elementary stream in question. Thus, for SI-FEC and for elementary stream with PID=A, the field 40 is filled with a value 41, namely PID=B.

Referring to FIG. 21, the time slice identifier descriptor 39 is used in a Network Information Table (NIT) 42 (step S12). In one embodiment of the present invention, the syntax of the NIT 42 is shown in Table 7 below:

TABLE 7

| Syntax | No. of bits | Identifier |
|---|---|---|
| network_information_section( ){ | | |
| table_id | 8 | uimsbf |
| section_syntax_indicator | 1 | bslbf |
| reserved_future_use | 1 | bslbf |
| Reserved | 2 | bslbf |
| section_length | 12 | uimsbf |
| network_id | 16 | uimsbf |
| Reserved | 2 | bslbf |
| version_number | 5 | uimsbf |
| current_next_indicator | 1 | bslbf |
| section_number | 8 | uimsbf |
| last_section_number | 8 | uimsbf |
| reserved_future_use | 4 | bslbf |
| network_descriptors_length | 12 | uimsbf |
| for(i=0;i<N;i++){ | | |

descriptor( )

| } | | |
|---|---|---|
| reserved_future_use | 4 | bslbf |
| transport_stream_loop_length | 12 | uimsbf |
| for(i=0;i<N;i++){ | | |

| | | |
|---|---|---|
| transport_stream_id | 16 | uimsbf |
| original_network_id | 16 | uimsbf |
| reserved_future_use | 4 | bslbf |
| transport_descriptors_length | 12 | uimsbf |
| for(j=0;j<N;j++){ | | |

descriptor( )
}

| } | | |
|---|---|---|
| CRC_32 | 32 | rpchof |

}

When located in a first descriptor loop 43, the descriptor 39 applies to all transport streams announced within the table. The descriptor 39 applies to all elementary streams having a given streamt_type field valueon any of the transport streams. In one embodiment of the present invention, a stream_type field value of 0x0D is used for elementary streams carrying MPE only streams. A stream_type field value of 0x80 may be used for elementary streams carrying MPE and FEC sections. A stream_type field value of between 0x80 and 0xFF may be used for elementary streams carrying only FEC section.

When located in a second descriptor loop 44, the descriptor 39 applies to the transport stream in question, specified by the transport_stream field. The descriptor applies to all elementary streams having a given stream_type field value. This descriptor 39 overwrites possible descriptors in the first descriptor loop.

In other embodiments of the invention, the descriptor 39 may be included in other types of tables, such as in an INT (not shown).

In the INT (not shown), when located in the platform descriptor loop, the descriptor 39 applies to all elementary streams referred to within the table. This descriptor 39 overwrites possible descriptors in the NIT.

In the INT (not shown), when located in the target descriptor loop, the descriptor 39 applies to all elementary streams referred within the target descriptor loop in question after the appearance of the descriptor. This descriptor overwrites possible descriptors in the platform descriptor loop and in the NIT. In case an elementary stream is referred from multiple locations within the INT, each contains the same signalling.

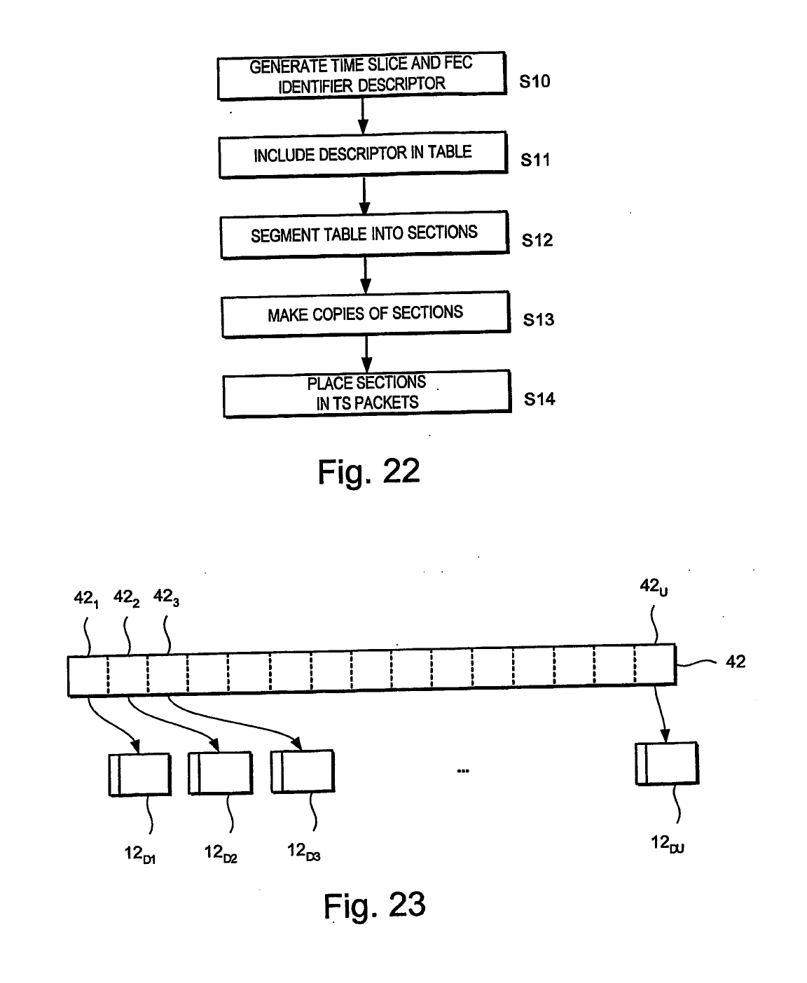

Referring to FIGS. 21 and 22, the controlling means 27 generates a time slicing and FEC descriptor 39 indicating PID=B in the si_fec/mpe_fec PID field 40 (step S10) and places the descriptor 39 in the NIT 42 in the second descriptor loop 44 (step S11).

Referring also to FIG. 23, the controlling means 27 segments the NIT 42 into table sections 42₁, 42₂, 42₃, 42_{U} (step S12), maps them into TS packets 12_{D1}, 12_{D2}, 12_{D3}, 12_{DU}, labeled in this case with PID=0x0010 and multiplexes the TS packets 12_{D1}, 12_{D2}, 12_{D3}, 12_{DU} into the transport stream 11 (step S13). A receiver usually only accesses the NIT 42 when connecting to the network 1 (FIG. 1).

A receiver may need to read the content of an INT (not shown) when changing from one transport stream 11 to another (not shown) and usually not more than once. Changes in the INT (not shown) can be signalled in PSI/SI using a PMT table (not shown), thus ensuring that constant filtering of the INT (not shown) is not required.

PSI/SI tables, such as the INT (not shown) and NIT 42, are usually re-transmitted at least once in every 100 ms. If the duration of a burst is longer than 100 ms, a receiver has access to all PSI tables while receiving a burst. For shorter bursts, a receiver may choose to keep switched on until all required PSI tables are received.

In an alternative embodiment of the present invention, the location of the copy of the service information and FEC may be pre-defined. In other words, value of PIDs A and B can be set by a standard. This has the advantage that a copy of the service information and associated FEC data can be located without receiving the original service information.

—Copied PSI/SI and SI Data 10′—

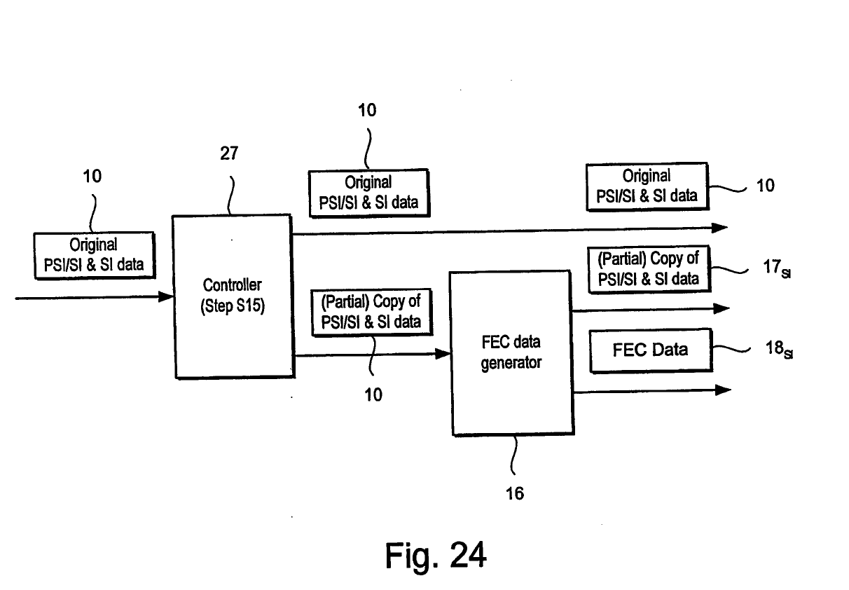

Referring to FIG. 24, as mentioned earlier, if the MPE encapsulator 6 does not receive a copy of the service information data 10, then the controlling means 27 generates a copy or partial copy 10′ of the service information data 10 (step S15). The controlling means 27 can modify the service information data 10 before or after generating the copy 10′, in particular by generating the time slicing and FEC descriptor 39 and placing it in the NIT 42 as described earlier. If the service information data 10 is modified before copying then a complete copy of the modified service information data 10 can be made.

Using the copy or partial copy 10′ of the service information, the FEC data generating means 16 generates SI data 17_{SI} and FEC data 18_{SI}. If no stuffing data is added during FEC code generation, the SI data 17_{SI} may comprise only the copy or partial 10′ of the service information.

The SI data 17_{SI} and FEC data 18_{SI} are placed in corresponding sets of sections 20_{SI}, 21_{SI}, preferably assembled into corresponding sets of burst 23_{SI}, 24_{SI} and encapsulated and multiplexed into stream 11 as described earlier.

Thus, the mobile terminal 2 can receive not only service information data 10 in the usual way, but also a copy or partial copy 10′ of the service information data 10, together with FEC data for enabling correction of the copied data 10′. If the service information data 10 received in the usual way is corrupted due to poor transmission conditions, service information data may still be acquired because errors in the copied data 10′ can be corrected.

Put differently, a new elementary stream is defined for transferring PSI/SI data and a further elementary stream can be defined for FEC data which can be easily synchronised to the PSI/SI data.

The SI data 17_{SI} may be arranged such that it comprises PSI/SI sections as they are transmitted conventionally in the transport stream. This helps the mobile terminal to incorporate copied data 10′ into the original data 10.

Mobile Terminal 2

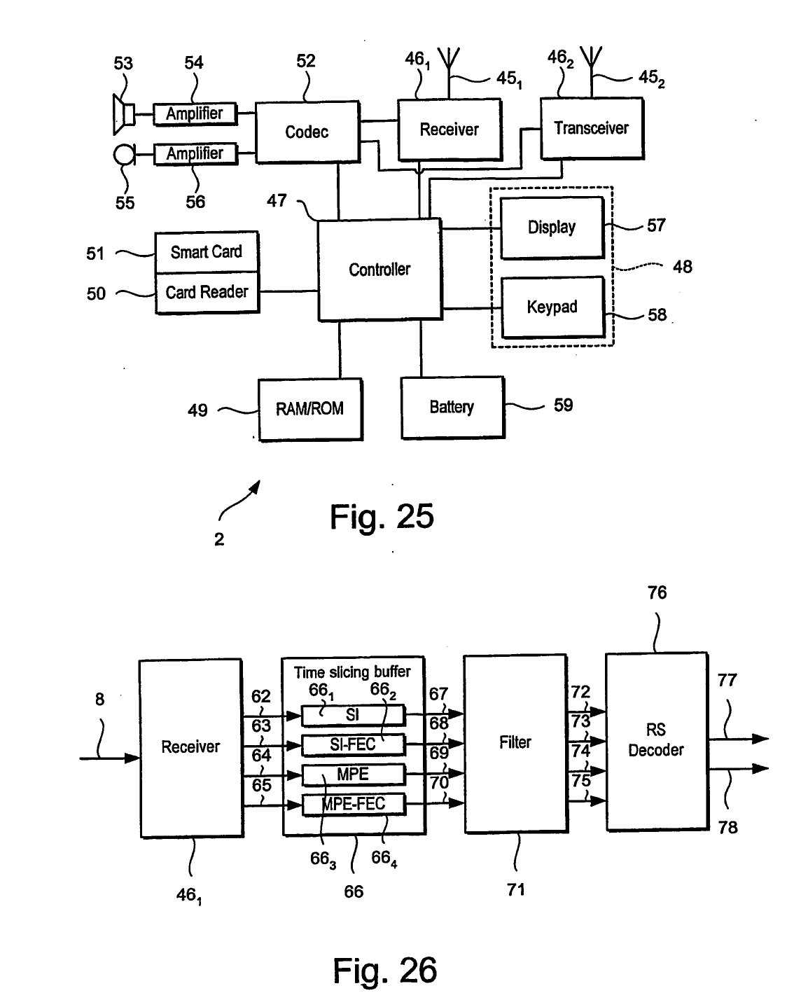

Referring to FIG. 25, mobile terminal 2 is preferably in the form of a mobile telephone handset with a multimedia capability.

The mobile terminal 2 includes first and second antennae 45₁, 45₂, a receiver 46₁ and a transceiver 46₂. In this example, the first antenna 45₁ and receiver 46₁ are used to receive signals from the communications network 1 (FIG. 1), in this case a DVB-T network. The second antenna 45₂ and transceiver 46₂ are used to transmit and receive signals to and from a second communications network, such as a PLMN (not shown). The receiver and transceiver 45₁, 46₂ each include respective r.f. signal processing circuits (not shown) for amplifying and demodulating received signals and respective processors (not shown) for channel decoding and demultiplexing.

The mobile terminal 2 also includes a controller 47, a user interface 48, memory 49, a smart card reader 50, smart card 51 received in the smart card reader 50, a coder/decoder (codec) 52, a speaker 53 with corresponding amplifier 54 and a microphone 55 with a corresponding pre-amplifier 56.

The user interface 48 comprises a display 57 and a keypad 58. The display 57 is adapted for displaying images and video by, for instance, being larger and/or having greater resolution than a display of conventional mobile telephone and being capable of colour images. The mobile terminal 2 also includes a battery 59.

The controller 47 manages operation of the mobile terminal 2 under the direction of computer software (not shown) stored in memory 49. For example, the controller 47 provides an output for the display 57 and receives inputs from the keypad 58.

The mobile terminal 2 may be modified by providing a single receiver adapted to receive signals from the first communications network 1 (FIG. 1) and the second communications network (not shown) and a transmitter adapted to transmit signals to the second communications network (not shown). Alternatively, a single transceiver for both communications networks may be provided.

Referring to FIG. 26, the receiver 46₁ is intermittently switched on to receive the signal 8 from the first communications network 1. The signal 8 is amplified, demodulated, channel decoded and demultiplexed preferably into first, second, third and fourth elementary streams 62, 63, 64, 65.

The first elementary stream 62 includes TS packets 12_{SIA1}, 12_{SIA2}, 12_{SIA3}, 12_{SIA4}, 12_{SIA5}, 12_{SIA6}, 12_{SIAS} (FIG. 15) carrying SI bursts 23₁, 23_{SI2} (FIG. 15). The second elementary stream 63 includes TS packets 12_{SIB1}, 12_{SIB2}, 12_{SIB3}, 12_{SIB4}, 12_{SIB6}, 12_{SIBT} (FIG. 16) carrying SI-FEC data bursts 24_{SI1}, 24_{SI2}, (FIG. 16). The third elementary stream 64 includes TS packets 12_{APPA1}, 12_{APPA2}, 12_{APPA3}, 12_{APPA4}, 12_{APPA5}, 12_{APPA6}, 12_{APPAS} (FIG. 17) carrying MPE bursts 23_{APP1} (FIG. 17). The fourth elementary stream 53 includes TS packets 12_{APPB1}, 12_{APPB2}, 12_{APPB3}, 12_{APPB4}, 12_{APPB5}, 12_{APPB6}, 12_{APPBT} (FIG. 18) carrying MPE-FEC data bursts 24_{APP1}, (FIG. 18).

The first, second, third and fourth elementary streams 62, 63, 64, 65 are fed into buffering means 66 comprising a first portion 66₁ for buffering SI bursts 23_{SI1}, 23_{SI2}, a second portion 66₂ for buffering SI-FEC data bursts 24_{SI1}, 24_{SI2}, 24_{SI3}, a third portion 66₃ for buffering MPE bursts 23_{APP1}, 23_{APP2} and a fourth portion 66₄ for buffering MPE-FEC data bursts 24_{APP1}, 24_{APP2}. The buffering means 66 is provided by controller 47 and memory 49. The buffering means 66 outputs first, second, third and fourth streams 67, 68, 69, 70 of sections which are not time sliced. Preferably, the streams 67, 68, 69, 70 is substantially continuous and/or at a substantially constant rate.

The streams 67, 68, 69, 70 are fed into a filtering means 71 which extracts data packets from sections and outputs corresponding streams 72, 73, 74, 75 of data packets.

The first data packet stream 72 ideally comprises SI data packets 17_{SI1}, 17_{SI2}, 17_{SI3}, 17_{SI4}, 17_{SIm}, 17_{SIp} (FIG. 6c). The second data packet stream 73 ideally comprises SI-FEC data packets 18_{SI1}, 18_{SI2}, 18_{SIq} (FIG. 6c). The third data packet stream 74 ideally comprises application data packets 17_{APP1}, 17_{APP2}, 17_{APP3}, 17_{APP4}, 17_{APPm*}, 17_{APPp} (FIG. 6c). The fourth data packet stream 75 ideally comprises MPE-FEC data packets 18_{SI1}, 18_{SI2}, 18_{SIq} (FIG. 6c). However, errors may have been introduced during transmission.

The streams 72, 73, 74, 75 are fed into a decoder 76 for performing forward error correction and outputting a stream of data packets 77, 78, namely service information data and application data respectively. In this example, the decoder 76 is a Read Solomon decoder.

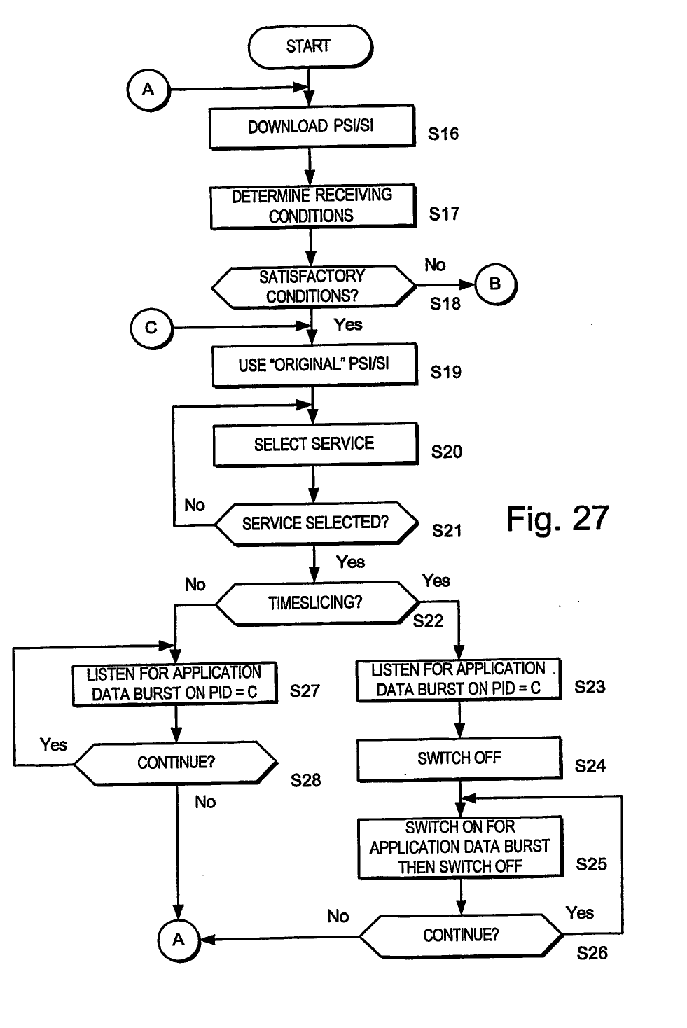

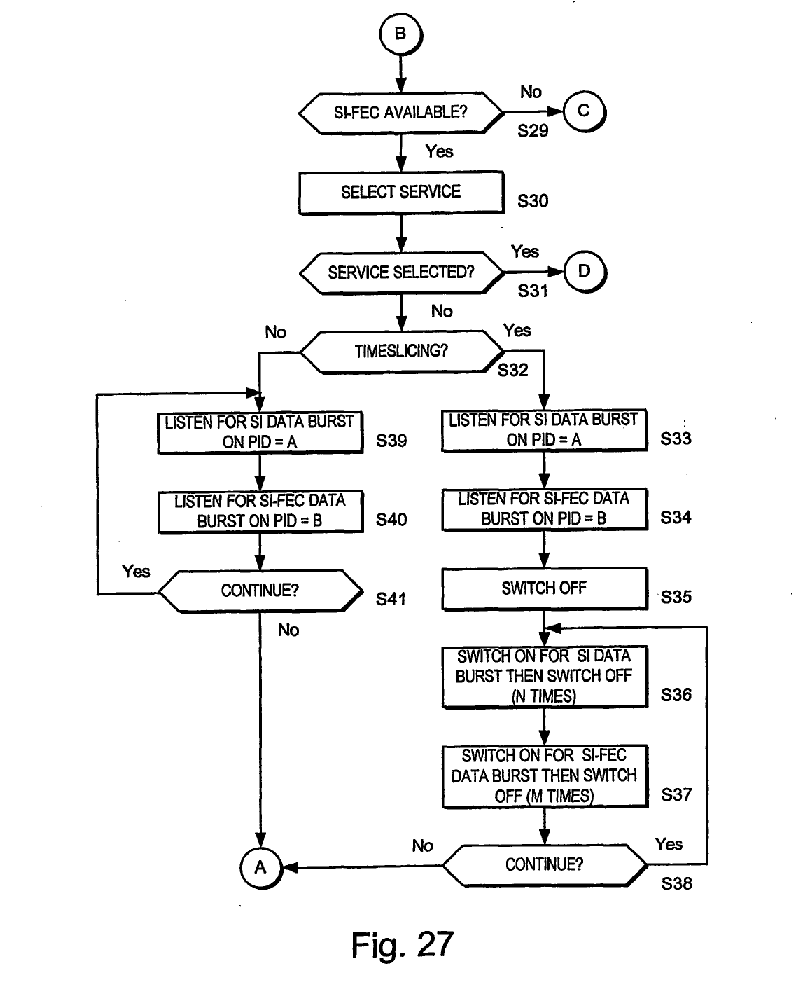

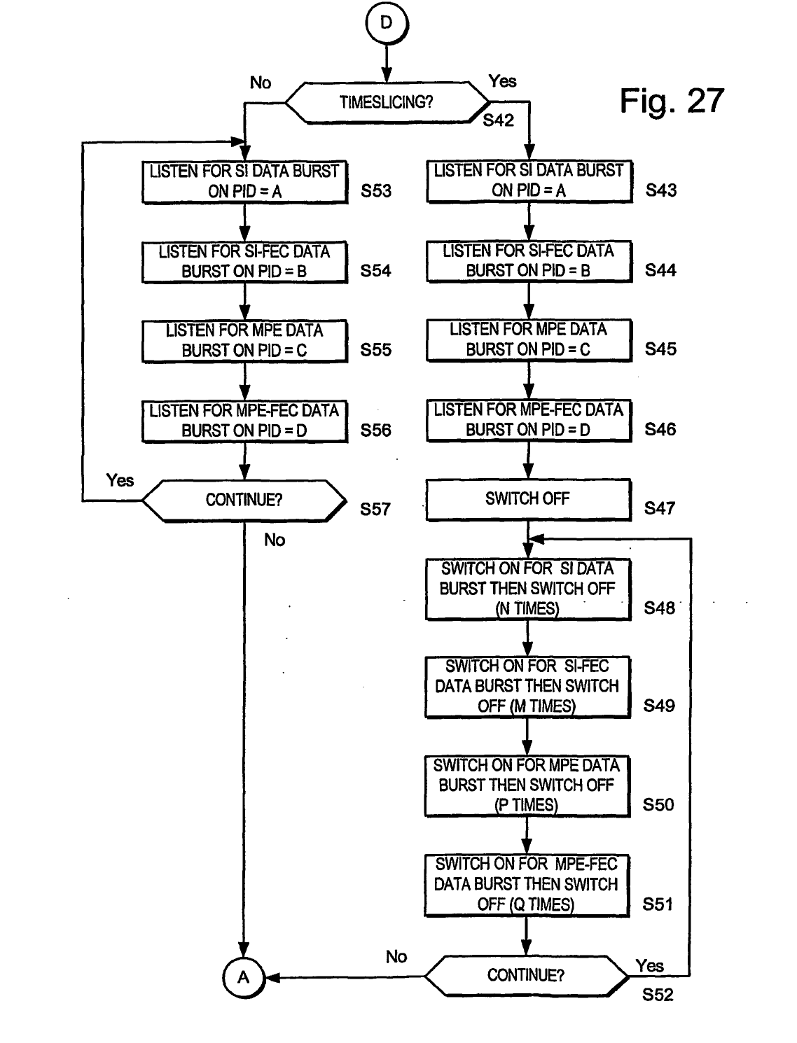

Referring to FIGS. 14, 25, 26 and 27, a method of operating the mobile terminal 2 will now be described in more detail:

When the mobile terminal 2 is switched on by the user, the controller 47 downloads, PSI/SI and SI data 10, including NIT 42 (FIG. 21) and INT (not shown), and stores the tables in memory 49 (steps S16). The tables may have been downloaded at other times and may be downloaded repeatedly.

The controller 47 determines receiving conditions (step S17) and determines whether the receiving conditions are satisfactory (step S18). Determination of receiving conditions may be based on received signal strength, detected bit error rate and/or other indicators. If receiving conditions are satisfactory, then the PSI/SI and SI data 10 is considered to be reliable (step S19).

The user may select a service, such as streaming video (steps S20 & S21). When a service is selected, the controller 47 looks up the PID for the service in the INT (not shown) and examines the NIT 42 (FIG. 21) to determine whether time slicing has been enabled for the service (step S22).

If so, the controller 47 instructs the receiver 46₁ to listen for application data burst 23_{APP1} comprised in TS packets with PID=C (step S23). Preferably, the receiver 46₁ remains switched on until it receives at least part of an application data burst 23_{APP1} and thus obtain a value of delta-t_{APPA}. If no other service is required, the controller 47 instructs the receiver 46₁ to switch off (step S24).

Based upon a received value of the delta-t_{A}, the controller 47 instructs the receiver 46₁ to switch on when the next application data burst 23_{APP2} is expected, receive the application burst 23_{APP2} and switch off (step S25). Receiving the application burst 23_{APP2} includes demodulating, decoding and demultiplexing the signal 8 and buffering the application burst 23_{APP2} in buffering means 66.

If service is still required (step S26), then the controller 47 continues to instruct the receiver 46₁ to switch on and off intermittently to receive further application data bursts (not shown).

If time slicing has not been enabled for the service, the controller 47 instructs the receiver 46₁ to continue listening for MPE sections (not shown) comprised in TS packets with PID=C (step S27) until service is no longer required (step S28).

If receiving conditions are not satisfactory, then the PSI/SI and SI data 10 is considered to be unreliable (step S18).

The controller 47 examines the NIT 42 (FIG. 21) to determine whether SI-FEC has been enabled (step S29). If SI-FEC has not been enabled, then the controller 47 has little choice but to continue using PSI/SI and SI data 10 (step S19). If, however, SI-FEC has been enabled then, a copy or partial copy 10′ of PSI/SI and SI data may be obtained.

If no service is selected (step S30 and S31), then the controller 47 sets about obtaining copy or partial copy 10′ of PSI/SI and SI data including RS data.

The controller 47 examines the NIT 42 (FIG. 21) to determine whether time slicing has been enabled for SI data (step S32).

If time slicing is enabled, the controller 47 instructs the receiver 46₁ to listen for SI data burst 23_{SI1} comprised in TS packets with PID=A (step S33) and to listen for SI-FEC data bursts 24_{SI1}, 24_{SI2} comprised in TS packets with PID=B (step S34). Preferably, the receiver 46₁ remains switched on until it receives at least part of an SI data burst 23_{SI1} and part of an SI-FEC data burst 24_{SI1}, thereby obtaining a value of delta-t_{SIA} and a value of delta-t_{SIB}. If no other service is required, the controller 47 instructs the receiver 46₁ to switch off (step S35).

Based upon a received value of delta-t_{SIA}, the controller 47 instructs the receiver 46₁ to switch on when the next SI data burst 23_{SI2} is expected, receive the SI data burst 23_{SI2} and switch off (step S 36). If further SI data bursts (not shown) are expected, then this process is repeated. Based upon a received value of delta-t_{SIB}, the controller 47 instructs the receiver 46₁ to switch on when the next SI-FEC data burst 24_{SI3} is expected, receive the SI-FEC data burst 24_{SI3} and switch off (step S37). If further SI-FEC data bursts (not shown) are expected, then this process is repeated. Receiving an SI data burst 23_{SI2} or SI-FEC data burst 24_{SI2} includes demodulating, decoding and demultiplexing the signal 8 and buffering the SI data burst 23_{SI2} or SI-FEC data burst 24_{SI2} in buffering means 66.

If further PSI/SI and SI data is still required (step S38), then the controller 47 continues to instruct the receiver 46₁ to switch on and off intermittently to receive further SI data bursts (not shown) and further SI-FEC data bursts (not shown).

If time slicing is not enabled, the controller 47 instructs the receiver 46₁ to continue listening for SI data and SI-FEC data sections comprised in TS packets with PID=A and PID=B respectively (steps S39 & S40) until service is no longer required (step S41).

If service has been selected (step S30 and S31), then the controller 47 sets about not only obtaining copy or partial copy 10′ of PSI/SI and SI data and associated RS data, but also obtaining application data and associated RS data.

The controller 47 examines the NIT 42 to determine whether time slicing has been enabled for SI data (step S42). For simplicity it is assumed that if time slicing has been enabled for PSI/SI and SI data, then time slicing has also been enabled for application data. However, this need not be the case.

If time slicing is enabled, the controller 47 instructs the receiver 46₁ to listen for SI data bursts 23_{SI1} comprised in TS packets with PID=A (step S43), to listen for SI-FEC data bursts 24_{SI1} comprised in TS packets with PID=B (step S44), to listen for MPE data bursts 23_{APP1} comprised in TS packets with PID=C (step S45) and to listen for MPE-FEC data bursts 24_{APP1} comprised in TS packets with PID=D (step S46). Preferably, the receiver 46₁ remains switched on until it receives at least part of each of the bursts 23_{SI1}, 24_{SI1}, 23_{APP1}, 24_{APP1} thereby obtaining a value of delta-t_{SIA}, a value of delta-t_{SIB}, a value of delta-t_{APPA} and a value of delta-t_{APPB}. If no other service is required, the controller 47 instructs the receiver 46₁ to switch off (step S47).

Based upon a received value of delta-t_{SIA}, the controller 47 instructs the receiver 46₁ to switch on when the next SI data burst 23_{SI2} is expected, receive the SI data burst 23_{SI2} and switch off (step S48). If further SI data bursts (not shown) are expected, then this process is repeated. Based upon a value of delta-t_{SIB}, the controller instructs the receiver 46₁ to switch on when the next SI-FEC data burst 24_{SI2} is expected, receive the SI-FEC data burst 24_{SI2} and switch off (step S49). If further SI-FEC data bursts (not shown) are expected, then this process is repeated.

Likewise, based upon a received value of delta-t_{APPA}, the controller 47 instructs the receiver 46₁ to switch on when the next MPE data burst 23_{APP2} is expected, receive the MPE data burst 23_{APP2} and switch off (step S50). If further MPE data bursts (not shown) are expected, then this process is repeated. Based upon a received value of delta-t_{APPB}, the controller 47 instructs the receiver 46₁ to switch on when the next MPE-FEC data burst 24_{APP2} is expected, receive the MPE-FEC data burst 24_{APP1} and switch off (step S51). If further MPE-FEC data bursts (not shown) are expected, then this process is repeated.

Receiving an SI data burst 23_{SI2} or SI-FEC data burst 24_{SI2} includes demodulating, decoding and demultiplexing the signal 8 and buffering the SI data burst 23_{SI2} or SI-FEC data burst 24_{SI2} in buffering means 66.

If further PSI/SI and SI data and/or application data is still required (step S52), then the controller 47 continues to instruct the receiver 46₁ to switch on and off intermittently to receive further SI data bursts (not shown) and SI-FEC data bursts (not shown) and/or MPE data bursts (not shown) and MPE-FEC data bursts (not shown).

If time slicing is not enabled, the controller 47 instructs the receiver 46₁ to listen for SI sections (not shown), SI-FEC sections (not shown), MPE sections (not shown) and MPE-FEC sections (not shown) comprised in TS packets with PID=A, PID=B, PID=C and PID=D respectively (step S53 to step S56) until service is no longer required (step S57).

Thus, in the same way that the mobile terminal 2 can receive application data and related FEC data as MPE and MPE-FEC sections respectively, so too can it receive PSI/SI and SI data and related FEC data as SI and SI-FEC sections respectively. Moreover, application data, related FEC data, PSI/SI and SI data and related FEC data can be transmitted as interleaved time-sliced bursts on different channels, each having different real time parameters.

It will be appreciated that many modifications may be made to the embodiments hereinbefore described. For example, the mobile terminal may be a personal data assistant (PDA) or other mobile terminal capable of at least of receiving signals via the first communications network 1. The mobile terminal may also be semi-fixed or semi-portable such as a terminal carried in vehicle, such as a car.

1. A method of signalling in a communications network in which service information data is transmitted via a first set of channels, the method comprising:
providing a copy of at least some of said service information data;
providing forward error correction (FEC) data for said copy; and
transmitting said copy and said FEC data via a second, different set of channels.

2. (canceled)

3. (canceled)

4. The method according to claim 1, wherein said copy of said at least some of said service information data comprises a first plurality of data packets and said FEC data comprises a second plurality of data packets and wherein the method further comprises:
placing said first plurality of data packets in a first plurality of sections and
placing said second plurality of data packets in a second plurality of sections.

5. The method according to claim 4, further comprising:
arranging said first plurality of sections into a first set of bursts and
arranging said second plurality of sections into a second set of bursts.

6. the method according to claim 4 further comprising:
placing said first plurality of sections in a first plurality of packets and
placing said first plurality of sections in a second plurality of packets.

7. The method according to claim 6, further comprising:
labelling said first plurality of packets with a first packet identifier; and
labelling said second plurality of packets with a second packet identifier.

8. The method according to claim 5, comprising:
providing a first parameter for indicating a timing offset between a first, earlier burst comprising at least some of said copy of said at least some of said service information data and a second, later burst comprising further of said copy of said at least some of said service information data; and
providing a second parameter for indicating a timing offset between a third, earlier burst comprising at least some of said FEC data and a fourth, later burst comprising further FEC data.

9. The method according to claim 8, further comprising:
placing said first parameter in a section included in said first burst and
placing said second parameter in a section included in said second burst.

10. (canceled)

11. (canceled)

12. (canceled)

13. (canceled)

14. The method according to claim 1, wherein said communications network is a unidirectional, digital broadcast system.

15. (canceled)

16. (canceled)

17. (canceled)

18. (canceled)

19. A method of signalling in a communications network in which service information data is transmitted, the method comprising:
providing forward error correction (FEC) data for at least some of said service information data; and
transmitting said at least some of said service information data and said FEC data.

20. The method according to claim 19, comprising:
transmitting said service information data via a first set of channels; and
transmitting said at least some of said service information data and said FEC data via a second, different set of channels.

21. A method of transmitting service information, the method comprising:
transmitting at least part of service information data as part of forward error correction data.

22. A method according to claim 21, wherein the service information data includes service information parameters.

23. A computer readable medium storing a computer program comprising computer program instructions for causing data processing apparatus
to transmit service information data via a first set of channels;
to provide a copy of at least some of said service information data;
to provide forward error correction (FEC) data for said copy; and
to transmit said copy and said FEC data via a second, different set of channels.

24. A method of operating a terminal configured to receive service information transmitted via a first set of channels, the method comprising:
receiving a copy of at least some of said service information data and FEC data for said copy via a second, different set of channels.

25. The method according to claim 24, further comprising:
decoding said copy of at least some of said service information data and said FEC data for said copy so as to so produce a corrected version of said copy of said at least some of said service information data.

26. (canceled)

27. A method of operating a terminal configured to receive service information, the method comprising:
receiving at least some service information data and FEC data for said at least some service information data.

28. (canceled)

29. (canceled)

30. A computer readable medium storing a computer program comprising computer program instructions for causing a terminal
to receive a copy of at least some of said service information data and FEC data for said copy via a second, different set of channels; and
to decode said copy of at least some of said service information data and said FEC data for said copy so as to so produce a corrected version of said copy of said at least some of said service information data.

31. A system of signalling in a communications network in which service information is transmitted via a first set of channels, the method comprising:
providing a copy of at least some of said service information data;
providing forward error correction (FEC) data for said copy;
transmitting said copy and said FEC data via a second, different set of channels.

32. A system of signalling in a communications network in which service information data is transmitted, the system comprising:
providing forward error correction (FEC) data for at least some of said service information data; and
transmitting said at least some of said service information data and said FEC data.

33. The system according to claim 32, comprising:
transmitting said service information data via a first set of channels; and
transmitting said at least some of said service information data and said FEC data via a second, different set of channels.

34. (canceled)

35. A network element configured to signal service information via a first, set of channels, the network element comprising:
means for providing a copy of at least some of said service information data;
means for providing forward error correction (FEC) data for said copy;
means for transmitting said copy and said FEC data via a second, different set of channels.

36. A network element for signalling service information, the network element comprising:
means for providing forward error correction (FEC) data for at least some of said service information data; and
means for transmitting said at least some of said service information data and said FEC data.

37. The network element according to claim 36, configured to transmit service information data via a first set of channels and to transmit said at least some of said service information data and said FEC data via a second, different set of channels.

38. The network element according to claim 35, which is an encapsulator.

39. A transmitter for signalling service information in a communications network, the transmitter comprising:
means for providing forward error correction (FEC) data for at least some service information data; and
means for transmitting said at least some of said service information data and said FEC data.

40. The transmitter according to claim 39, configured to transmit service information data via a first set of channels and to transmit said at least some of said service information data and said FEC data via a second, different set of channels.

41. A transmitter for signalling service information in a communications network, the transmitter comprising:
means for transmitting at least some of said service information data and forward error correction (FEC) for said service information data.

42. A terminal configured to receive service information transmitted via a first channel, comprising:
means for receiving a copy of at least some of said service information data and forward error correction (FEC) data for said copy via a second, different set of channels.

43. A terminal configured to receive service information, comprising:
means for receiving at least some of service information data and forward error correction (FEC) data for said at least some of said service information.

44. The terminal according to claim 43, configured to receive service information data via a first set of channels and to receive said at least some of said service information data and said FEC data via a second, different set of channels.

45. A receiver for receiving service information, the receiver comprising:
means for receiving forward error correction (FEC) data for at least part of transmitting part of service information data as part of forward error correction data.

46. (canceled)

47. The method according to claim 1, further comprising:
including in said service information data at least one of the following parameters:
a parameter for indicating that said copy is being transmitted via second channel;
a parameter for indicating that said FEC data is being transmitted via third channel;
a parameter for indicating that said copy is being transmitted in a set of time-sliced bursts; and
a parameter for indicating that said FEC data is being transmitted in a set of time-sliced bursts.
